(19) United States
(12) Patent Application Publication
(10) Pub. No.: US 2025/0193904 A1
(43) Pub. Date: Jun. 12, 2025

(54) FLOATING SIDELINK SYNCHRONIZATION SIGNAL BLOCK FOR TIME DOMAIN REPETITION

(71) Applicant: QUALCOMM INCORPORATED, San Diego, CA (US)

(72) Inventors: Siyi Chen, Beijing (CN); Jing Sun, San Diego, CA (US); Xiaoxia Zhang, San Diego, CA (US); Changlong Xu, Beijing (CN); Shaozhen Guo, Beijing (CN); Luanxia Yang, Beijing (CN); Hao Xu, Beijing (CN); Chih-Hao Liu, San Diego, CA (US)

(21) Appl. No.: 18/838,927

(22) PCT Filed: Apr. 20, 2022
(86) PCT No.: PCT/CN2022/087870

§ 371 Date: Aug. 15, 2024

(51) Int. Cl. H04W 72/25; H04W 56/00; H04W 72/0446

(52) U.S. Cl. CPC H04W 72/25; H04W 56/0025; H04W 72/0446

(57) ABSTRACT

Methods, systems, and devices for wireless communications are described. A transmitting user equipment (UE) may transmit repetitions of sidelink synchronization signal blocks (S-SSBs) in the time domain to a receiving UE to increase signal strength and reliability. The transmitting CE may receive a message from the network which indicates an S-SSB timing configuration for a timing window including multiple S-SSB transmission occasions within an S-SSB period, along with an indication of a periodicity and a duration of the timing window. The transmitting UE may then participate in at least one listen-before-talk (LBT) procedure during the timing window to access the sidelink channel. In such cases, the number of S-SSB occasions in the timing window may be numerous to compensate for possible failure of at least one LBT procedure. Based on a successful outcome of at least one LBT procedure, the UE may transmit one or more repetitions of the S-SSB.

### CROSS REFERENCE

The present Application is a 371 national stage filing of International PCT Application No. PCT/CN2022/087870 by CHEN et al. entitled “FLOATING SIDELINK SYNCHRONIZATION SIGNAL BLOCK FOR TIME DOMAIN REPETITION,” filed Apr. 20, 2022, which is assigned to the assignee hereof, and which is expressly incorporated by reference in its entirety herein.

### FIELD OF TECHNOLOGY

The following relates to wireless communications, including a floating sidelink synchronization signal block for time domain repetition.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

In some cases, multiple UEs may perform sidelink communications using repeated sidelink synchronization signal block (S-SSB) transmissions. In some cases, however, the signal strength and reliability of the repeated S-SSB transmissions along with techniques for sidelink channel access using the S-SSBs may be improved.

### SUMMARY

The described techniques relate to improved methods, systems, devices, and apparatuses that support floating sidelink synchronization signal block (S-SSB) for time domain repetition. For example, the described techniques may increase signal strength and improve the success rate of the sidelink communications between user devices in a wireless communications system. In some examples, a transmitting user equipment (UE) may transmit repetitions of S-SSBs in the time domain to a receiving UE. The transmitting UE may receive a message from the network which indicates an S-SSB timing configuration for a timing window that includes multiple S-SSB transmission occasions and that is within an S-SSB period. In addition, the message may also include an indication of a periodicity and a duration of the timing window within the S-SSB period. The transmitting UE may then participate in at least one listen-before-talk (LBT) procedure during the duration of the timing window to attempt to access the sidelink channel. In such cases, the number of S-SSB occasions in the timing window may be numerous in order to compensate for failure of one or more of the LBT procedures, thus allowing the transmitting UE an opportunity to transmit the S-SSB transmissions with a defined number of repetitions despite the failure of an LBT procedure. For example, in cases that a first LBT fails, the transmitting UE may attempt to access the sidelink channel in a next S-SSB occasion in the configured timing window, where the timing window may be large enough to still allow for the determined number of S-SSB repetitions. Based on a successful outcome of at least one LBT procedure, the transmitting UE may transmit one or more repetitions of the S-SSB in accordance with the S-SSB timing configuration. Additionally or alternatively, the transmitting UE may implement one or more slot indexing techniques to more efficiently determine or indicate slot locations of the S-SSBs within the timing window.

A method for wireless communication is described. The method may include receiving, from a network entity, a message indicating a S-SSB timing configuration for a timing window that includes multiple S-SSB transmission occasions and that is within a S-SSB period, the message also indicative of a periodicity and a duration of the timing window within the S-SSB period, participating in at least one LBT procedure during the duration of the timing window; the multiple S-SSB transmission occasions provided by the S-SSB timing configuration being more numerous than a number of configured repetitions of a S-SSB within the timing window in order to compensate for failure of a portion of the at least one LBT procedure, and transmitting one or more instances of the S-SSB in accordance with the S-SSB timing configuration and an outcome of the at least one LBT procedure.

An apparatus for wireless communication is described. The apparatus may include a processor, memory coupled with the processor, and instructions stored in the memory. The instructions may be executable by the processor to cause the apparatus to receive, from a network entity, a message indicating a S-SSB timing configuration for a timing window that includes multiple S-SSB transmission occasions and that is within a S-SSB period, the message also indicative of a periodicity and a duration of the timing window within the S-SSB period, participate in at least one LBT procedure during the duration of the timing window; the multiple S-SSB transmission occasions provided by the S-SSB timing configuration being more numerous than a number of configured repetitions of a S-SSB within the timing window in order to compensate for failure of a portion of the at least one LBT procedure, and transmit one or more instances of the S-SSB in accordance with the S-SSB timing configuration and an outcome of the at least one LBT procedure.

Another apparatus for wireless communication is described. The apparatus may include means for receiving, from a network entity, a message indicating a S-SSB timing configuration for a timing window that includes multiple S-SSB transmission occasions and that is within a S-SSB period, the message also indicative of a periodicity and a duration of the timing window within the S-SSB period, means for participating in at least one LBT procedure during the duration of the timing window; the multiple S-SSB transmission occasions provided by the S-SSB timing configuration being more numerous than a number of configured repetitions of a S-SSB within the timing window in order to compensate for failure of a portion of the at least one LBT procedure, and means for transmitting one or more instances of the S-SSB in accordance with the S-SSB timing configuration and an outcome of the at least one LBT procedure.

A non-transitory computer-readable medium storing code for wireless communication is described. The code may include instructions executable by a processor to receive, from a network entity, a message indicating a S-SSB timing configuration for a timing window that includes multiple S-SSB transmission occasions and that is within a S-SSB period, the message also indicative of a periodicity and a duration of the timing window within the S-SSB period, participate in at least one LBT procedure during the duration of the timing window, the multiple S-SSB transmission occasions provided by the S-SSB timing configuration being more numerous than a number of configured repetitions of a S-SSB within the timing window in order to compensate for failure of a portion of the at least one LBT procedure, and transmit one or more instances of the S-SSB in accordance with the S-SSB timing configuration and an outcome of the at least one LBT procedure.

Some examples of the method, apparatuses, and non-transitory computer-readable medium described herein may further include operations, features, means, or instructions for determining a failure of a first LBT procedure during a first LBT occasion of the timing window and participating in at least a second LBT procedure in a second LBT occasion following the first LBT occasion of the timing window based on the duration, where the duration of the timing window may be sufficient to allow the number of configured repetitions of the S-SSB to be transmitted despite the failure of the first LBT procedure.

In some examples of the method, apparatuses, and non-transitory computer-readable medium described herein, receiving the message indicating the S-SSB timing configuration may include operations, features, means, or instructions for identifying that the S-SSB timing configuration includes more S-SSB transmission occasions than the number of configured repetitions of the S-SSB.

In some examples of the method, apparatuses, and non-transitory computer-readable medium described herein, the S-SSB timing configuration further indicates a value for an offset and the method, apparatuses, and non-transitory computer-readable medium may include further operations, features, means, or instructions for participating in a first LBT procedure at a first S-SSB occasion of the timing window, where the value for the offset indicates a timing for the first S-SSB occasion relative to a beginning of the S-SSB period.

In some examples of the method, apparatuses, and non-transitory computer-readable medium described herein, transmitting the one or more instances of the S-SSB may include operations, features, means, or instructions for transmitting the one or more instances of the S-SSB consecutively in the timing window within the S-SSB period.

In some examples of the method, apparatuses, and non-transitory computer-readable medium described herein, the periodicity of the timing window may be equal to a periodicity of the S-SSB period.

In some examples of the method, apparatuses, and non-transitory computer-readable medium described herein, the periodicity of the timing window includes 160 milliseconds.

In some examples of the method, apparatuses, and non-transitory computer-readable medium described herein, the periodicity of the timing window may be equal to a periodicity of the S-SSB period divided by a quantity of bursts of the multiple S-SSB transmission occasions within the S-SSB period.

In some examples of the method, apparatuses, and non-transitory computer-readable medium described herein, the duration may be greater than a length of the number of configured repetitions of the S-SSB within the S-SSB period.

Some examples of the method, apparatuses, and non-transitory computer-readable medium described herein may further include operations, features, means, or instructions for receiving, from the network entity, a radio resource control message that indicates the S-SSB timing configuration.

In some examples of the method, apparatuses, and non-transitory computer-readable medium described herein, the S-SSB timing configuration, the periodicity, the duration of the timing window, or any combination thereof, may be preconfigured at the user equipment (UE).

Some examples of the method, apparatuses, and non-transitory computer-readable medium described herein may further include operations, features, means, or instructions for including, within the one or more instances of the S-SSB, information indicative of a slot index configuration for each of the one or more instances of the S-SSB, where the slot index configuration includes a common portion for each of the one or more instances of the S-SSB.

Some examples of the method, apparatuses, and non-transitory computer-readable medium described herein may further include operations, features, means, or instructions for determining, in accordance with the slot index configuration, a set of slot indices for identifying multiple slot locations corresponding to the one or more instances of the S-SSB, where each slot index of the set of slot indices include multiple most significant bits (MSBs), multiple least significant bits (LSBs), and a toggle bit.

In some examples of the method, apparatuses, and non-transitory computer-readable medium described herein, a value of the multiple LSBs for a first slot index may be equal to a value of the multiple LSBs at a later slot index and the method, apparatuses, and non-transitory computer-readable medium may include further operations, features, means, or instructions for identifying a timing difference between the first slot index and the later slot index based on the toggle bit of the first slot index being different from the toggle bit of the later slot index.

In some examples of the method, apparatuses, and non-transitory computer-readable medium described herein, a value of the multiple LSBs for a first slot index may be equal to a value of the multiple LSBs at a later slot index and the method, apparatuses, and non-transitory computer-readable medium may include further operations, features, means, or instructions for identifying a timing difference between the first slot index and the later slot index based on a single bit of the multiple MSBs of the first slot index being different from a single bit of the multiple MSBs of the later slot index.

In some examples of the method, apparatuses, and non-transitory computer-readable medium described herein, a value of the toggle bit may be changed at a boundary of a subset of the multiple slot locations corresponding to the one or more instances of the S-SSB, the change in the toggle bit indicating a first repetition of multiple least significant bit values corresponding to slot indices of the subset of the multiple slot locations.

Some examples of the method, apparatuses, and non-transitory computer-readable medium described herein may further include operations, features, means, or instructions for receiving the multiple MSBs, the multiple LSBs, and the toggle bit in a sidelink broadcast channel.

Some examples of the method, apparatuses, and non-transitory computer-readable medium described herein may further include operations, features, means, or instructions for determining a first set of MSBs of the multiple MSBs associated with a first slot index of a first synchronization signal block (SSB) and determining respective sets of MSBs of the multiple MSBs associated with slot indices that follow the first slot index, where the respective sets of MSBs may have a same value as the first set of MSBs.

In some examples of the method, apparatuses, and non-transitory computer-readable medium described herein, the slot index configuration further indicates a value for an offset and a repetition index within the S-SSB period and the method, apparatuses, and non-transitory computer-readable medium may include further operations, features, means, or instructions for transmitting a first set of bits corresponding to the offset and a second set of bits corresponding to the repetition index and identifying multiple slot locations corresponding to the one or more instances of the S-SSB based on the offset and the repetition index.

In some examples of the method, apparatuses, and non-transitory computer-readable medium described herein, the offset includes a time duration between a beginning of a frame and a first transmitted S-SSB of the one or more instances of the S-SSB.

In some examples of the method, apparatuses, and non-transitory computer-readable medium described herein, the offset may be based on successfully performing the at least one LBT procedure.

In some examples of the method, apparatuses, and non-transitory computer-readable medium described herein, the repetition index indicates slot indices of the multiple slot locations within the S-SSB period.

Some examples of the method, apparatuses, and non-transitory computer-readable medium described herein may further include operations, features, means, or instructions for determining the multiple slot locations based on a direct frame number, a system frame number, the offset, the repetition index, or any combination thereof.

A method for wireless communication is described. The method may include receiving one or more S-SSBs within a timing window that includes multiple S-SSB reception occasions and that is within a S-SSB period and receiving, within the one or more S-SSBs, information indicative of a slot index configuration for each of the one or more S-SSBs, where the slot index configuration includes a portion that is common for each of the one or more S-SSBs.

An apparatus for wireless communication is described. The apparatus may include a processor, memory coupled with the processor, and instructions stored in the memory. The instructions may be executable by the processor to cause the apparatus to receive one or more S-SSBs within a timing window that includes multiple S-SSB reception occasions and that is within a S-SSB period and receive, within the one or more S-SSBs, information indicative of a slot index configuration for each of the one or more S-SSBs, where the slot index configuration includes a portion that is common for each of the one or more S-SSBs.

Another apparatus for wireless communication is described. The apparatus may include means for receiving one or more S-SSBs within a timing window that includes multiple S-SSB reception occasions and that is within a S-SSB period and means for receiving, within the one or more S-SSBs, information indicative of a slot index configuration for each of the one or more S-SSBs, where the slot index configuration includes a portion that is common for each of the one or more S-SSBs.

A non-transitory computer-readable medium storing code for wireless communication is described. The code may include instructions executable by a processor to receive one or more S-SSBs within a timing window that includes multiple S-SSB reception occasions and that is within a S-SSB period and receive, within the one or more S-SSBs, information indicative of a slot index configuration for each of the one or more S-SSBs, where the slot index configuration includes a portion that is common for each of the one or more S-SSBs.

In some examples of the method, apparatuses, and non-transitory computer-readable medium described herein, a periodicity of the timing window may be equal to a periodicity of the S-SSB period or to a periodicity of the S-SSB period divided by a quantity of the multiple S-SSB reception occasions within the S-SSB period.

Some examples of the method, apparatuses, and non-transitory computer-readable medium described herein may further include operations, features, means, or instructions for determining, in accordance with the slot index configuration, a set of slot indices for identifying multiple slot locations corresponding to the one or more S-SSBs, where each slot index of the set of slot indices include multiple MSBs, multiple LSBs, and a toggle bit and identifying a timing difference between a first slot index and a later slot index based on the toggle bit of the first slot index being different from the toggle bit of the later slot index.

In some examples of the method, apparatuses, and non-transitory computer-readable medium described herein, a value of the multiple LSBs for the first slot index may be equal to a value of the multiple LSBs at the later slot index and the method, apparatuses, and non-transitory computer-readable medium may include further operations, features, means, or instructions for identifying the timing difference between the first slot index and the later slot index based on a single bit of the multiple MSBs of the first slot index being different from a single bit of the multiple MSBs of the later slot index.

In some examples of the method, apparatuses, and non-transitory computer-readable medium described herein, the slot index configuration further indicates a value for an offset and a repetition index within the S-SSB period and the method, apparatuses, and non-transitory computer-readable medium may include further operations, features, means, or instructions for receiving a first set of bits corresponding to the offset and a second set of bits corresponding to the repetition index and identifying multiple slot locations corresponding to the one or more S-SSBs based on the offset and the repetition index.

### BRIEF DESCRIPTION OF THE DRAWINGS

FIGS. 1 and 2 illustrate examples of wireless communications systems that support floating sidelink synchronization signal block (S-SSB) for time domain repetition in accordance with one or more aspects of the present disclosure.

FIGS. 3 through 5 illustrate examples of S-SSB timing configurations that support floating S-SSB for time domain repetition in accordance with one or more aspects of the present disclosure.

FIG. 6 illustrates an example of a process flow that supports floating S-SSB for time domain repetition in accordance with one or more aspects of the present disclosure.

FIGS. 7 and 8 show block diagrams of devices that support floating S-SSB for time domain repetition in accordance with one or more aspects of the present disclosure.

FIG. 9 shows a block diagram of a communications manager that supports floating S-SSB for time domain repetition in accordance with one or more aspects of the present disclosure.

FIG. 10 shows a diagram of a system including a device that supports floating S-SSB for time domain repetition in accordance with one or more aspects of the present disclosure.

FIGS. 11 through 15 show flowcharts illustrating methods that support floating S-SSB for time domain repetition in accordance with one or more aspects of the present disclosure.

### DETAILED DESCRIPTION

Some wireless communications systems may support sidelink signaling between user equipment (UE) operating in a high frequency unlicensed band (e.g., a 6 GHz band). To reliably communicate via a sidelink UEs may transmit synchronization information for sidelink transmissions, similar to synchronization information transmitted between a UE and the network via uplink and downlink signaling. In sidelink, such synchronization information is carried in sidelink synchronization signal blocks (S-SSBs) that include the physical sidelink broadcast channel (PBSCH), the sidelink primary synchronization signal (S-PSS) and the sidelink secondary synchronization signal (S-SSS). To increase signal strength and to improve the success rate of the S-SSB transmissions, a transmitting UE may transmit repetitions of the SSBs (e.g., an SSB burst) in the time domain to a receiving UE. To access the sidelink channel for transmitting the S-SSB repetitions, the transmitting UE may perform one or more listen-before-talk (LBT) procedures at a number of different starting points of the S-SSB burst to reduce the chances of total LBT failure for the burst. So, for a burst of several S-SSB repetitions, if LBT fails in a first occasion, the transmitting UE can try to access the medium in the second LBT occasion of the burst. But even so, if the LBT failure occurs in the first occasion, the S-SSB repetition could be less than the number indicated by the network, which effects the S-SSB coverage.

In some other examples, the transmitting UE may transmit a number of least significant bits (LSBs) along with a set of most significant bits (MSBs) in a demodulation reference signal (DMRS) symbol of the S-SSBs to indicate a slot index for a slot that the receiving UE may use to access the sidelink channel. In such cases, the transmitting UE may transmit a set of LSBs every eight S-SSBs such that the DMRS is different, but the payload of physical sidelink broadcast channel (PS-BCH) is the same so that S-SSB combination can be performed without hypothesis. In some cases, however, the PS-BCH payload may be different across the eight S-SSBs boundary (e.g., based on the S-SSB repetitions), such that the UE has to make different hypotheses on which MSBs are used for each of the eight S-SSBs. In such cases, the blind decoding complexity may be high for identifying the correct slot indices to use for access to the sidelink channel.

In order to mitigate some of these existing concerns, in a first example, the transmitting UE may receive a message from a network entity that includes an indication of an S-SSB reception timing configuration (SRTC) which indicates a certain number (e.g., N) of SSB occasions that are available within a configured SRTC window for transmitting S-SSBs in an S-SSB period. The SRTC may include a periodicity and duration of the timing window within the S-SSB period, along with an offset from the start of the S-SSB period. Thus, in cases that LBT fails in a first LBT occasion, the transmitting UE can try to access the medium in an immediate second S-SSB occasion of the SRTC window.

Additionally or alternatively, the transmitting UE may implement one or more slot indexing techniques to more efficiently determine or indicate slot locations of the S-SSBs within an SRTC window. In a first example, the transmitting UE may implement absolute slot indexing procedures. For example, in some cases there may be 10 slots (e.g., slots 0 through 9) within an SRTC window, and the slots may be indexed using three LSBs, which may be individually numbered through 8 slot indices (e.g., 000, 001, 010, 011, 100, 101, 110, 111). Thus, in some cases, the slots may be repeatedly indexed (e.g., when the 8 slot indices are used up through 111, the slot indices may start over or “wrap around” at a ninth slot using 000 as the slot index). In such cases, the transmitting UE may change the value of a toggle bit in the PS-BSCH which indicates the repeated indexing (e.g., a first slot may have a toggle bit of 0 and LSBs of 000, where a ninth slot may have a toggle bit of 1 and LSBs of 000). The introduction of this toggle bit may allow the UE to identify locations for performing LBT for transmitting the SSBs in the SRTC window, and may allow a receiving UE to properly determine timing information for decoding the SSBs in an SRTC window. In some other examples, the SRTC may indicate a starting position and repetition index within the S-SSB burst such that the transmitting UE may identify locations for performing LBT within the SRTC window; and such that the UE 115-b may identify locations for decoding SSBs within the SRTC window.

Aspects of the disclosure are initially described in the context of wireless communications systems. Aspects of the disclosure are further illustrated by and described with reference to apparatus diagrams, system diagrams, SSB timing configurations, a process flow, and flowcharts that relate to floating S-SSB for time domain repetition in high frequency bands.

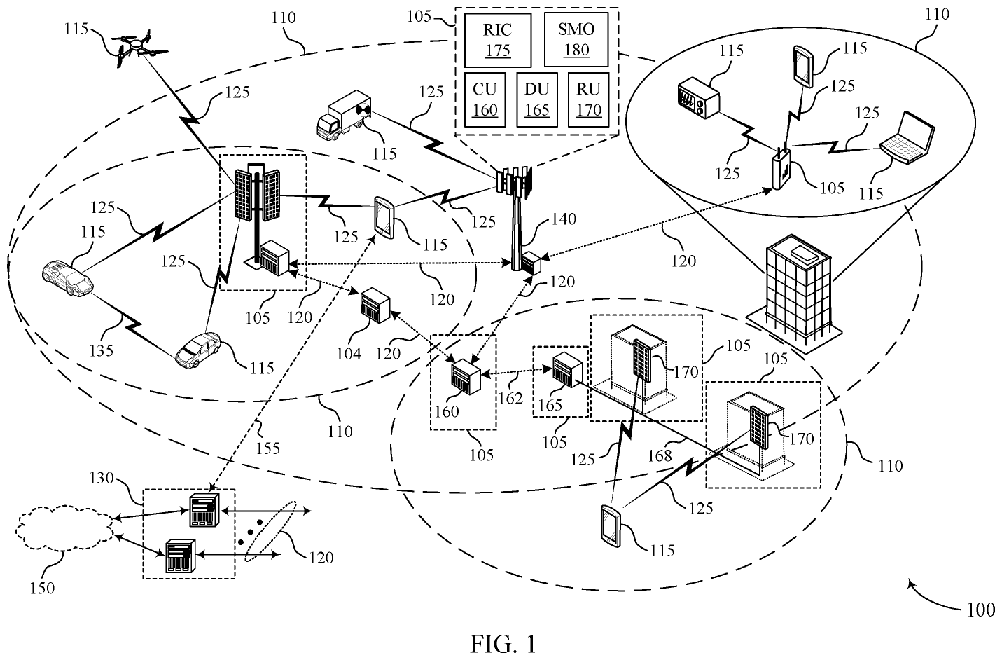

FIG. 1 illustrates an example of a wireless communications system 100 that supports floating S-SSB for time domain repetition in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another over a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 through a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 175 is flexible and may support different functionalities depending upon which functions (e.g., network layer functions, protocol layer functions, baseband functions, RF functions, and any combinations thereof) are performed at a CU 160, a DU 165, or an RU 175. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication over such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 over an interface (e.g., a backhaul link). IAB donor and IAB nodes 104 may communicate over an F1 interface according to a protocol that defines signaling messages (e.g., an F1 AP protocol). Additionally, or alternatively, the CU 160 may communicate with the core network over an interface, which may be an example of a portion of backhaul link, and may communicate with other CUs 160 (e.g., a CU 160 associated with an alternative IAB donor) over an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, and referred to as a child IAB node associated with an IAB donor. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, and may directly signal transmissions to a UE 115. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling over an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support floating S-SSB for time domain repetition as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) over one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications over a particular carrier bandwidth or may be configurable to support communications over one of a set of carrier bandwidths. In some examples, the wireless communications system 100 may include network entities 105 or UEs 115 that support concurrent communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both) such that the more resource elements that a device receives and the higher the order of the modulation scheme, the higher the data rate may be for the device. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating over a limited bandwidth (e.g., according to narrow band communications), or a combination of these techniques. For example, some UEs 115 may be configured for operation using a narrow band protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be able to communicate directly with other UEs 115 over a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by or scheduled by the network entity 105. In some examples, one or more UEs 115 in such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without the involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, which may be referred to as clusters, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below: 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. While operating in unlicensed RF spectrum bands, devices such as the network entities 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located in diverse geographic locations. A network entity 105 may have an antenna array with a set of rows and columns of antenna ports that the network entity 105 may use to support beamforming of communications with a UE 115. Likewise, a UE 115 may have one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

In some wireless communications systems 100, a UE 115 may transmit sidelink communication in an unlicensed band, which may include a 5 GHz band and a 6 GHz band (e.g., an expanded unlicensed use of the 6 GHz band). Multiple UEs 115 in the wireless communications system 100 may perform sidelink communications by transmitting S-SSBs. A bandwidth of an SSB may have a bandwidth spanning 11 physical resource blocks (PRBs) which include a combination of PS-BCHs, S-PSSs, S-SSSs, and demodulation reference signals (DMRSs). For example, the S-SSB may include 11 PRBs and 9 OFDM symbols for a normal cyclic prefix (NCP) or 7 OFDM symbols for an extended cyclic prefix (ECP), where a first PS-BCH symbol may be used for automatic gain control (AGC) training at a receiving UE 115. A PS-BCH may include 56 payload bits which include bits for a direct frame number (DFN) (e.g., 10 bits), an indication of a TDD configuration (e.g., 12 bits, which may include system-wide information including a TDD-uplink-downlink common configuration, potential sidelink slots, or both), a slot index (e.g., 7 bits), an in-coverage indicator (e.g., 1 bit), reserve bits (e.g., 2 bits), and a cyclic redundancy check (e.g., 24 bits). In addition, the S-SSB may include S-PSSs, which may span a bandwidth of 127 (e.g., a maximum-length sequence) PRBs, have a same generator or initial value as some Uu PSSs (e.g., with cyclic shifts of 22 and 65), and be repeated on two consecutive symbols. The S-SSB may also include S-SSSs, which may span a bandwidth of 127 (e.g., a Gold-code sequence), have a same generator or initial value and same cyclic shifts as Uu SSSs, and be repeated on two consecutive symbols. Additionally, the S-SSB may include a DMRS in each PS-BCH symbol and each fourth resource element, and the last symbol of the S-SSB may include a gap symbol.

In some examples, a UE 115 may transmit an S-SSB with a periodicity of 160 ms for any subcarrier spacing (SCS). A network entity may configure a quantity of S-SSBs that UEs 115 may transmit within a period (e.g., 160 ms) for a given SCS. For example, in frequency range 1 (FR1), the UE 115 may transmit 1 S-SSB in a period for a 15 kHz SCS, 1 or 2 S-SSBs in a period for a 30 KHz SCS, and 1, 2, or 4 S-SSBs in a period for a 60 KHz SCS. In frequency range 2 (FR2), the UE 115 may transmit up to 32 S-SSBs (e.g., 1, 2, 4, 8, 16, or 32 S-SSBs) in a period for a 60 kHz SCS, and up to 64 S-SSBs (e.g., 1, 2, 4, 8, 16, 32, or 64 S-SSBs) in a period for a 120 kHz SCS. In some examples, a transmit UE 115 may transmit an S-SSB to a receive UE 115 (e.g., in sidelink communications with the transmit UE 115) to perform a synchronization procedure.

In some examples, the wireless communications system 100 may support sidelink communications between different UEs 115. For example, the first UE and the second UE may perform sidelink communications in an unlicensed band. In some examples, the first UE may receive a message from a network entity indicating that the first UE is to transmit multiple S-SSB repetitions within an S-SSB period (e.g., spanning 160 ms). In some cases, the message may indicate that the first UE is transmit the repetitions of the S-SSBs in the time domain (e.g., in multiple slots), for example, to increase a received signal strength of the S-SSBs. In some examples, the message from the network entity may include a sidelink configuration indicating that the first UE is to transmit the S-SSBs within an S-SSB instance of an S-SSB period. For example, the sidelink configuration may indicate that the first UE is to transmit four S-SSBs, within an S-SSB instance of an S-SSB period, where the S-SSB period spans 160 ms. That is, the sidelink configuration may indicate that the first UE is to transmit four repetitions of the S-SSB within the S-SSB instance. In some examples, the S-SSB instance may be offset from the beginning of the S-SSB period.

In some examples, a quantity of S-SSB instances within an S-SSB period may remain unchanged, where the quantity of S-SSB repetitions (e.g., a repetition number) may be indicated in an RRC parameter (e.g., SL-NumRepetitionSSB in SL-SyncConfig). For example, the first UE may use the RRC parameter to indicate a quantity of S-SSBs for inclusion within each S-SSB instance (e.g., a repetition number). The first UE may determine the quantity of S-SSBs for inclusion within each S-SSB instance based on an RRC parameter of the sidelink configuration indicated by the network entity.

In addition, a time interval (e.g., sl-TimeInterval) may be configured such that the S-SSBs in an S-SSB instance refrain from overlapping with each other after a repetition. For example, a time interval may span the S-SSB instance plus a gap after the S-SSB instance, where the gap provides space between the S-SSB instance and the S-SSB instance to prevent the S-SSB instances from overlapping with each other. Put another way, the time interval may define an interval between starting times of consecutive S-SSB instances, such that S-SSBs may be included in each of the consecutive S-SSB instances without overlapping.

In some examples, the first UE and the second UE may perform sidelink communications in an unlicensed band. In some examples, the first UE may receive a message from a network entity indicating that the first UE is to transmit S-SSBs (e.g., multiple S-SSB repetitions) within an S-SSB period (e.g., spanning 160 ms) in the time domain (e.g., in multiple slots). The message from the network entity may include a sidelink configuration indicating that the first UE is to transmit the S-SSBs in multiple S-SSB instances of an S-SSB period (e.g., 160 ms). In some examples, the sidelink configuration may indicate that the first UE is to transmit four S-SSBs in four corresponding S-SSB instances in an S-SSB period. That is, the first UE may transmit four repetitions of the S-SSBs in four repeated S-SSB instances during the S-SSB period (e.g., with a repetition number, K=4).

In some other examples, the first UE and the second UE may perform sidelink communications in an unlicensed band. In some examples, the first UE may receive a message from a network entity indicating that the first UE is to transmit multiple S-SSBs (e.g., S-SSB repetitions) within an S-SSB period. The first UE may determine one or more LBT occasions in association with the S-SSBs. The first UE may participate in an LBT procedure during the LBT occasion. If the LBT procedure is successful, the first UE may transmit the S-SSBs to the second UE.

In some cases, the first UE may perform one or more LBT procedures at different times (e.g., starting points) to prevent LBT failure, where the different times may correspond to different LBT occasions. As the timing of the LBT occasions may be based on the consecutively transmitted S-SSBs, the LBT occasions may occur before each S-SSB is to be transmitted. If an LBT procedure fails during the LBT occasion, the first UE may participate in a second LBT procedure before a different S-SSB.

The first UE may identify a first LBT occasion associated with a temporally first S-SSB transmitted within the S-SSB period. The first UE may participate in a first LBT procedure during the LBT occasion, which may be unsuccessful. Accordingly, the first UE may identify one or more additional LBT occasions that temporally follow the LBT occasion. The first UE may then participate in an LBT procedure a following LBT occasion, and may transmit the S-SSB within the S-SSB period to the second UE if the LBT procedure during the LBT occasion is successful.

In some examples, the first UE may perform an unsuccessful LBT procedure during LBT occasions. The first UE may identify a first LBT occasion associated with a temporally first S-SSB within an S-SSB period. The first UE may participate in a first LBT procedure during the LBT occasion, which may be unsuccessful. After the unsuccessful first LBT procedure during the LBT occasion, the first UE may identify one or more additional LBT occasions that temporally follow the LBT occasion, which the first UE may use to perform a potentially successful LBT procedure.

In some examples, a transmitting UE 115 may receive a message from a network entity 105 that includes an indication of an SRTC which indicates a certain number (e.g., N) SSB occasions that are available within a configured SRTC window for transmitting S-SSBs in an S-SSB period. The SRTC may include a periodicity and duration of the timing window within the S-SSB period, along with an offset from the start of the S-SSB period. Thus, in cases that LBT fails in a first LBT occasion, the transmitting UE can try to access the medium in an immediate second S-SSB occasion of the SRTC window.

Additionally or alternatively, the transmitting UE may implement absolute slot indexing procedures to identify slots for transmitting S-SSBs. For example, in some cases there may be 10 slots (e.g., slots 0 through 9) within an SRTC window, and the slots may be indexed using three LSBs, which may be individually numbered through 8 slot indices (e.g., 000, 001, 010, 011, 100, 101, 110, 111). Thus, in some cases, the slots may be repeatedly indexed (e.g., when the 8 slot indices are used up through 111, the slot indices may start over or “wrap around” at a ninth slot using 000 as the slot index). In such cases, the transmitting UE 115 may change the value of a toggle bit in the PS-BSCH which indicates the repeated indexing (e.g., a first slot may have a toggle bit of 0 and LSBs of 000, where a ninth slot may have a toggle bit of 1 and LSBs of 000). The introduction of this toggle bit may allow the transmitting UE 115 to identify locations for performing LBT for transmitting the SSBs in the SRTC window, and may allow a receiving UE to properly determine timing information for decoding the SSBs in an SRTC window. In some other examples, the SRTC may indicate a starting position and repetition index within the S-SSB burst such that the transmitting UE may identify locations for performing LBT within the SRTC window, and such that the receiving UE may identify locations for decoding SSBs within the SRTC window.

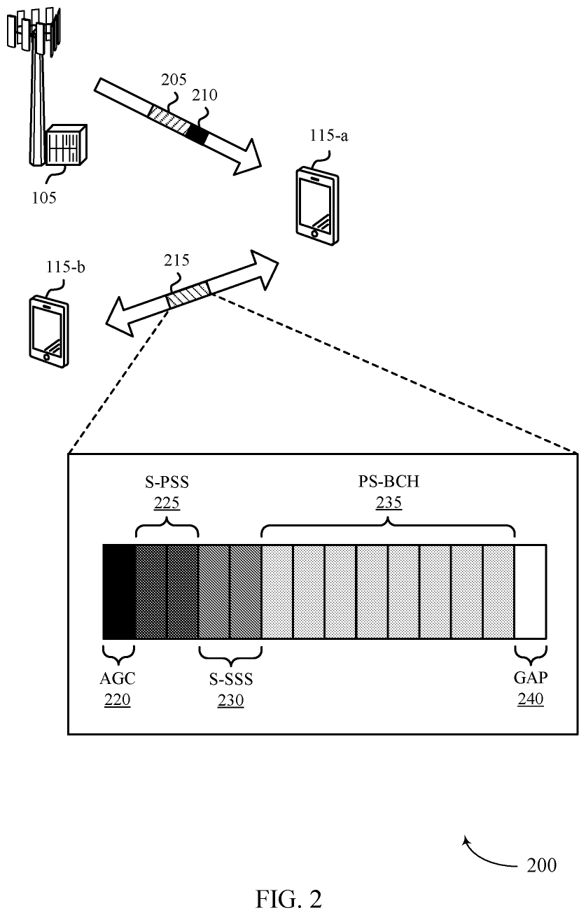

FIG. 2 illustrates an example of a wireless communications system 200 that supports floating S-SSB for time domain repetition in accordance with one or more aspects of the present disclosure. In some examples, the wireless communications system 200 may implement aspects of the wireless communications system 100 or may be implemented by aspects of the wireless communications system 100. For example, the wireless communications system 200 may include a network entity 105, a UE 115-a, and a UE 115-b, which may be examples of corresponding devices described herein.

In some examples, the network entity 105 may communicate directly with the UE 115-a via a communications link (e.g., a downlink), and the UE 115-a may communicate with the UE 115-b via a sidelink. In some examples, the UE 115-a and the UE 115-b may operate in a high frequency unlicensed band (e.g., a 6 GHz band). As described herein, the UE 115-a (e.g., the transmitting UE) may transmit multiple S-SSB 215 repetitions to the UE 115-b (e.g., a receiving UE) in the time domain or the frequency domain to increase the signal strength of an S-SSB 215 and to increase the likelihood that the UE 115-b successfully receives the S-SSB transmissions.

In some cases, the UE 115-a may transmit repetitions of the S-SSBs 215 to the UE 115-b in the time domain in the high frequency unlicensed band. The UE 115-a may receive a message 205 from the network entity 105 which indicates that the UE 115-a is to transmit the S-SSBs 215 within an S-SSB period to the UE 115-b, for example, in multiple slots. In some examples, the structure of the S-SSBs may include a slot 220 designated for AGC training, slots 225 designated for transmitting S-PSS, slots 230 designated for the S-SSS, slots 235 designated for the transmission of the PS-BCH, and a gap slot 240. To access the sidelink channel for transmitting the S-SSB repetitions, the UE 115-a may perform an LBT procedure at a number of different starting points of the S-SSB burst to reduce the chances of total LBT failure for the burst. In some examples, the UE 115-a may participate in an LBT procedure during one or more LBT occasions. For example, the UE 115-a may participate in a successful LBT procedure during a first LBT occasion before transmitting a first S-SSB. If the LBT procedure fails during the first LBT occasion, the UE 115-a may participate in the LBT procedure in one or more additional LBT occasions until the LBT procedure is successful. Following a successful LBT procedure, the UE 115-a may transmit at least one of the S-SSB 215. For example, if the LBT procedure is successful in the first LBT occasion, the UE 115-a may transmit. If the LBT procedure initially fails in one or more LBT occasions, the UE 115-a may transmit fewer LBTs than a quantity initially indicated by the network entity 105 in the message 205.

In some cases, however, LBT may fail in a first occasion for a burst of several S-SSB repetitions (e.g., S-SSBs 215), and the UE 115-a can try to access the medium in the second LBT occasion of the burst. But if the LBT failure occurs in the first occasion, the S-SSB repetition will be less than the number indicated by the network entity, which effects the S-SSB coverage. In some examples, the UE 115-a may transmit a number of LSBs (e.g., three LSBs) along with a set of MSBs in a DMRS symbol of the S-SSBs to indicate a slot index for a slot that the UE 115-b to use to access the sidelink channel. In such cases, the UE 115-a may transmit a set of LSBs every eight S-SSBs such that the DMRS is different, but the payload of PS-BCH is the same so that S-SSB combination can be performed without hypothesis. In some cases, however, the PS-BCH payload 235 may be different across the eight S-SSBs boundary (e.g., based on the S-SSB repetitions), such that the UE 115-a has to make different hypotheses on which MSBs are used for each of the eight S-SSBs. In such cases, the blind decoding complexity may be high for identifying the correct slot indices to use for access to the sidelink channel.

In a first example, the message received by the transmitting UE 115-a from the network entity 105 may include an indication of an S-SSB reception timing configuration (SRTC) 210 which indicates a certain number (e.g., N) SSB occasions that are available within a configured SRTC window for transmitting S-SSBs in an S-SSB period. The SRTC 210 may include a periodicity and duration of the timing window within the S-SSB period, along with an offset from the start of the S-SSB period. Thus, in cases that LBT fails in a first LBT occasion, the UE 115-a can effectively try to access the medium in an immediate second S-SSB occasion of the SRTC window.

Additionally or alternatively, the UE 115-a may implement one or more slot indexing techniques to more efficiently determine slot locations of the S-SSBs within the SRTC. In a first example, the UE 115-a support absolute slot indexing procedures. For example, in some cases there may be 10 slots (e.g., slots 0 through 9) within an SRTC window, and the slots may be indexed using three LSBs, with combinations that extend through 8 slot indices (e.g., 000, 001, 010, 011, 100, 101, 110, 111). Thus, in some cases, the slots may need to be repeatedly indexed (e.g., when the 8 slot indices are used up through 111, the slot indices may start over or “wrap around” at 000). In such cases, there may be a toggle bit in the PS-BSCH which indicates the repeated indexing (e.g., a first slot may have a toggle bit of 0 and LSBs of 000, where a ninth slot may have a toggle bit of 1 and LSBs of 000). The introduction of this toggle bit may allow the UE 115-a to identify locations for performing LBT for transmitting the SSBs in the SRTC window, and may allow the UE 115-b to properly determine timing information for decoding the SSBs in an SRTC window. In some other examples, the SRTC 210 may indicate a starting position and repetition index within the S-SSB burst such that the UE 115-a may identify locations for performing LBT within the SRTC window, and such that the UE 115-b may identify locations for decoding SSBs within the SRTC window.

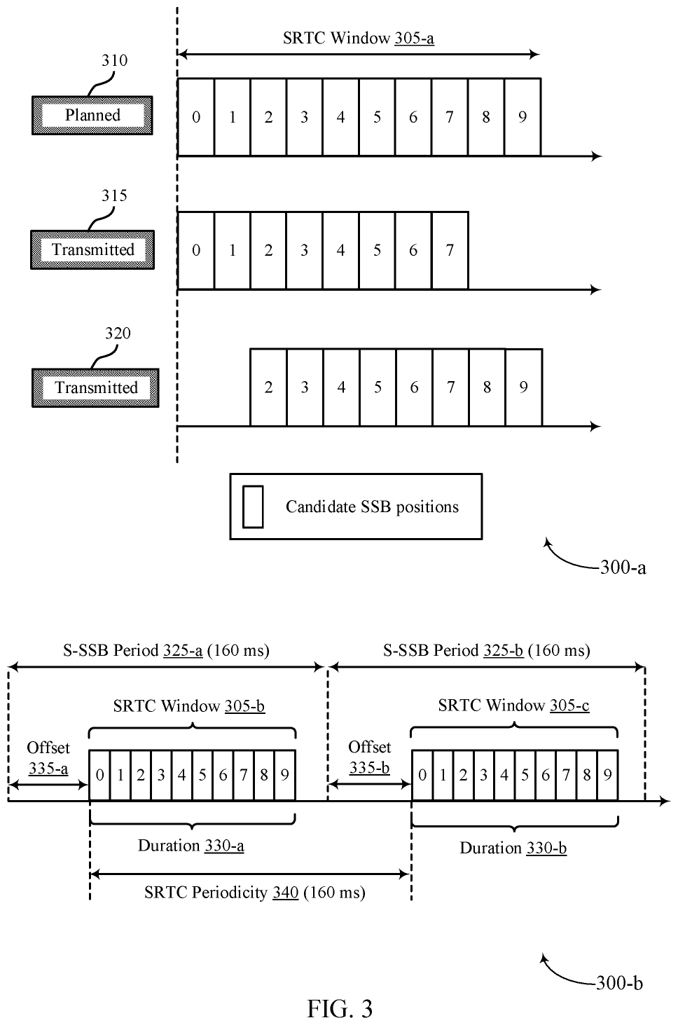

FIG. 3 illustrates example S-SSB timing configurations 300-a and 300-b that support floating S-SSB for time domain repetition in accordance with one or more aspects of the present disclosure. In some examples, the S-SSB timing configurations 300-a and 300-b may implement aspects of the wireless communications system 100 and 200 or may be implemented by aspects of the wireless communications systems 100 and 200. For example, the S-SSB timing configurations 300-a and 300-b may be implemented at or by a network entity and sidelink devices described herein.

S-SSB timing configuration 300-a shows an SRTC window that includes a number of candidate S-SSB positions that a first sidelink UE may use for performing LBT and transmitting sidelink information to a second sidelink UE. In some cases, the first sidelink UE may receive an S-SSB reception timing configuration (e.g., SRTC) which indicates a number of S-SSB planned occasions 310 that are available within the SRTC window 305-a (within an S-SSB period). In some examples, the number of S-SSB occasions (e.g., N SSBs) included in the SRTC window 305-a may be larger than the number of S-SSB repetitions in the S-SSB period. In some examples, the configured SRTC window 305-a may support more complete coverage for transmitting S-SSBs, even if some LBT failure occurs in some of the S-SSB occasions. For example, the SRTC window may support planned S-SSB transmissions 310 in slots 0 through 9. In some cases, the UE may perform LBT and may successfully transmit S-SSBs in occasions 1 through 7 (e.g., transmitted S-SSBs 315) and, based on the successful transmission of the S-SSBs in occasions 1 through 7, may refrain from performing LBT and transmitting S-SSBs in slots 8 and 9. In some other cases (e.g., transmitted S-SSBs 320), the UE may experience LBT failure in slots 0 and 1, but may still be able to perform LBT and transmit S-SSBs in slots 2 through 9. In cases that the UE experiences LBT failure during the SRTC window (e.g., transmitted S-SSBs 320), the UE may be able to continue to try to perform LBT and transmit S-SSBs during the configured SRTC window.

S-SSB timing configuration 300-b may show a set of SRTC windows 305-b and 305-c that are configured in adjacent S-SSB periods 325-a and 325-b, each S-SSB period spanning 160 ms. In some examples, a transmitting UE may receive a message (e.g., a radio resource control (RRC) configuration message) from a network entity that includes various parameters as part of the SRTC. For example, the SRTC may include both a periodicity 340 and duration (e.g., duration 330-a and 330-b) of the SRTC window 305. In addition, the SRTC may include an indication of an offset 335 between the beginning of the S-SSB period (e.g., equal to SFN mod16=0) and a first transmitted S-SSB. In some examples, the offset may be included in a control parameter (e.g., sl-TimeOffsetSSB-r16) that is received by the transmitting UE. Additionally or alternatively, the parameters indicated by the SRTC may be configured or preconfigured at the transmitting UE.

The periodicity and duration of the SRTC window may have a number of different values indicated by the SRTC. In some examples, the SRTC periodicity 340 may be equal to the S-SSB periodicity (e.g., 160 ms). In some other examples, the SRTC periodicity 340 may be equal to the S-SSB periodicity divided by a value K (e.g., SRTC periodicity=S-SSB periodicity/K), where K is the number of S-SSB instants (e.g., 0 through 9) within one periodicity. In some examples, the duration of the SRTC windows 305 may be larger than the total S-SSB repetition length.

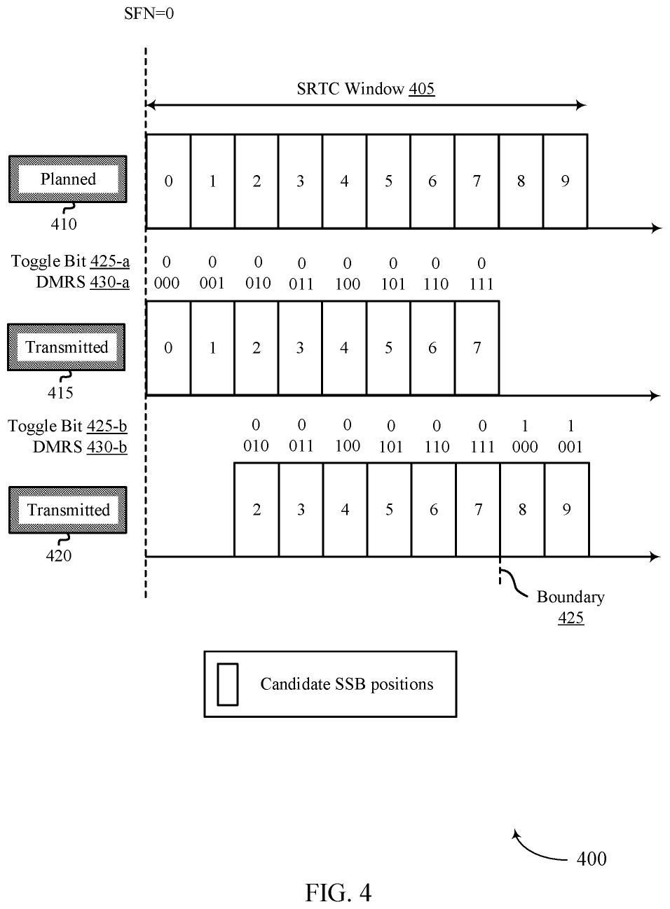

FIG. 4 illustrates an example of an S-SSB timing configuration 400 that supports floating S-SSB for time domain repetition in accordance with one or more aspects of the present disclosure. In some examples, the S-SSB timing configuration 400 may implement aspects of the wireless communications system 100 and 200 or may be implemented by aspects of the wireless communications systems 100 and 200. For example, the S-SSB configuration 400 may be implemented at or by a network entity and sidelink devices described herein.

In some implementations, a UE may implement one or more slot indexing techniques to efficiently determine slot locations of candidate S-SSBs within an SRTC 405. In a first example, the UE may support an absolute slot indexing procedure. For example, at 410 there may be 10 slots (e.g., slots 0 through 9) that are planned for transmission within an SRTC window 405, and the slots may be indexed using three LSBs within DMRS, with combinations that extend through 8 slot indices (e.g., 000, 001, 010, 011, 100, 101, 110, 111). In such cases, the slot indices may also be defined using a set of MSBs in a PS-BCH payload that remain constant (e.g., MSB is frozen to the MSB of slot index to the first transmitted S-SSB), and a toggle bit that may be based on respective indices. For example, for the eight slots of transmitted occasion 415, the slot indices may indicate an MSB of 0000, LSBs 430-a of 000, 001, 010, 011, 100, 101, 110, 111 for slots 0, 1, 2, 3, 4, 5, 6, and 7, respectively, and toggle bit values 425-a of 0 for each slot.

In some cases, however, the slots may need to be repeatedly indexed in cases where the SRTC window 405 includes more than eight candidate SSB positions (e.g., when the 8 slot indices are used up through 111, the slot indices may start over or “wrap around” at 000). In such cases, for example, in transmitted S-SSBs 420, the toggle bit in the PS-BSCH may be used to indicate the repeated indexing (e.g., a first slot may have a toggle bit of 0 and LSBs of 000, where a ninth slot may have a toggle bit of 1 and LSBs of 000). The introduction of this toggle bit may allow the UE to identify locations for performing LBT for transmitting the S-SSBs in the SRTC window, and may allow the UE to properly determine timing information for decoding the SSBs in an SRTC window. For example, to indicate the wrap-around of slot indices, the toggle bit may change from 0 to 1 across the eight S-SSB boundary 425 so that a single hypothesis may be used for the soft combination toggle bit.

Based on the addition of the toggle bit, the UE may effectively determine timing information for the S-SSB positions in the SRTC window. The UE may decode the PS-BCH to obtain the MSB of the slot index and the value of the toggle bit. In cases that the toggle bit is equal to 0, the UE may use the slot index directly, that is, the UE may determine that the slot index corresponds to one of the first eight slots of the SRTC window. In cases that the toggle bit is equal to 1, the UE may add eight slots to determine the timing information for the slot, that is, the slot index has wrapped around, and corresponds to a second set of slots of the SRTC window.

Additionally or alternatively, in some cases where the subcarrier spacing for the candidate SSB positions is less than a threshold (e.g., less than 120 kHz), one MSB of the set of MSBs may be reused to indicate the wrap-around of slot indices.

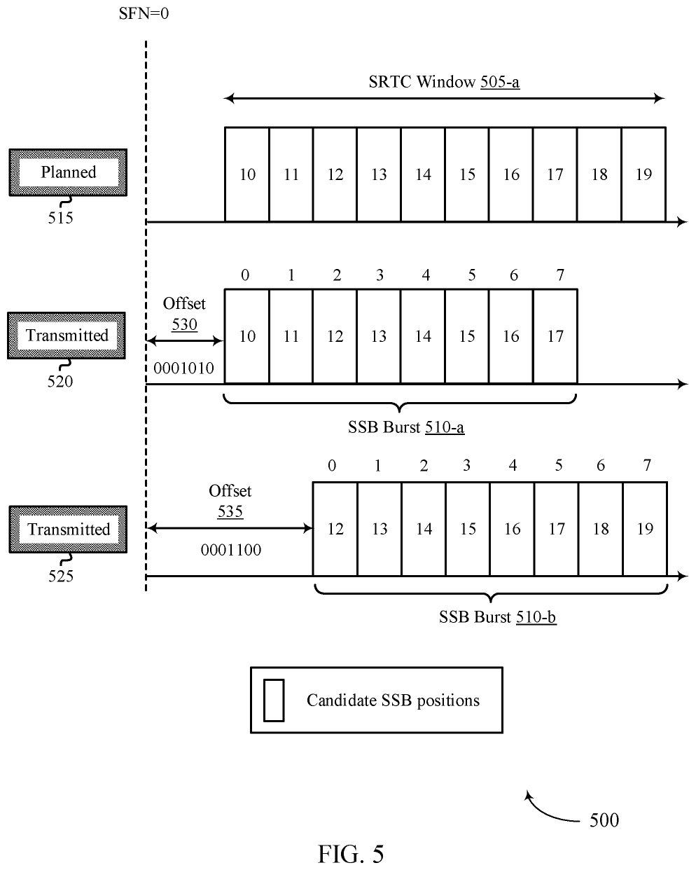

FIG. 5 illustrates an example of a S-SSB timing configuration 500 that supports floating S-SSB for time domain repetition in accordance with one or more aspects of the present disclosure. In some examples, the S-SSB timing configuration 500 may implement aspects of the wireless communications system 100 and 200 or may be implemented by aspects of the wireless communications systems 100 and 200. For example, the S-SSB timing configuration 500 may be implemented at or by a network entity and sidelink devices described herein.

In some implementations, a UE may implement one or more slot indexing techniques to efficiently determine slot locations of candidate S-SSBs within an SRTC window 505. In some examples, the SRTC may indicate a starting position and repetition index within an S-SSB burst (e.g., SSB burst 525-a and 525-b) such that a transmitting UE may identify locations for performing LBT within the SRTC window 505-a, and such that a receiving UE may identify locations for decoding SSBs within the SRTC window 505-a.

For example, slot indices in the transmitted S-SSBs 520 and 525 may be indicated by a slot offset (e.g., 7 bits in the PS-BCH payload) and repetition index within the burst (e.g., 3 bits in DMRS). In such cases, the slot offset may span from the start of one frame to the first S-SSB occasion. For example, the slot offset 530 indicated by 0001010 may span from the beginning of the frame to the SSB candidate 10, and the slot offset 535 indicated by 0001100 may span from the beginning of the frame to the SSB candidate 12. In some implementations, the slot offset may be a function of LBT such that the transiting UE encodes the master information block (MIB) after LBT success for the sidelink slot-based transmissions. In such cases, there may be a duration of time between the LBT success point and a next slot boundary. In addition, the slots in the SRTC window 505-a may be identified based on the repetition index, which may include indices from 0 to Y−1 (e.g., 0, . . . , Y−1) within one S-SSB burst 510. Accordingly, the slot index for the S-SSBs may be deduced from the DFN, SFN, slot offset in the PS-BCH, and the repetition index within the burst.

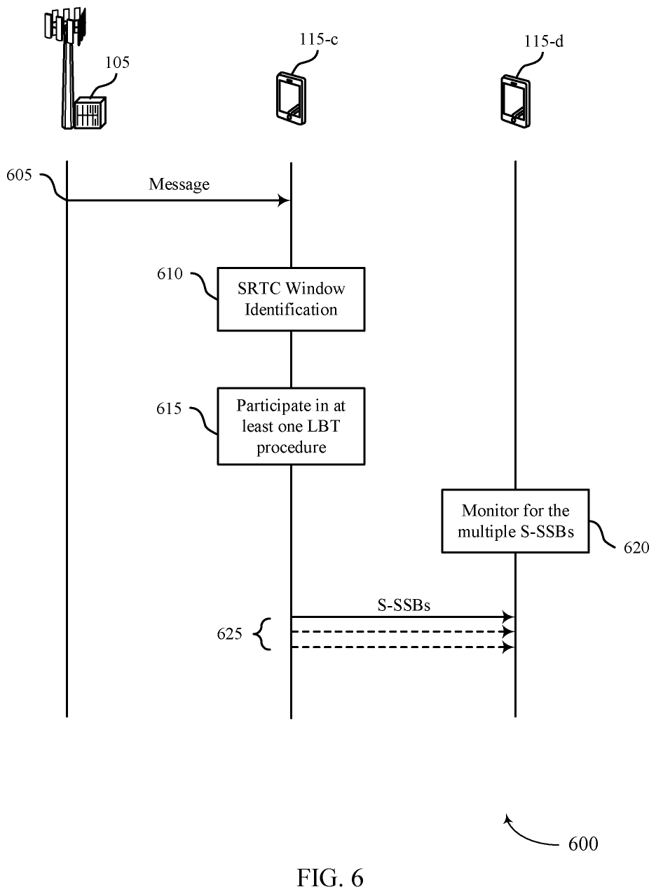

FIG. 6 illustrates an example of a process flow 600 that supports floating S-SSB for time domain repetition in accordance with one or more aspects of the present disclosure.

For example, the process flow 600 may illustrate operations between a UE 115-c, a UE 115-d, and a network entity 105, which may be examples of corresponding devices described herein. In the following description of the process flow 600, the operations between the UE 115-c, the UE 115-d, and the network entity 105 may be transmitted in a different order than the example order shown, or the operations performed by the UE 115-c, the UE 115-d, and the network entity 105 may be performed in different orders or at different times. Some operations may also be omitted from the process flow 600, and other operations may be added to the process flow 600.

At 605, the network entity 105 may transmit, and the UE 115-c may receive, a message (e.g., and RRC configuration message) which indicates an SRTC configuration and an associated SRTC timing window that includes multiple S-SSB transmission occasions and that is within a S-SSB period. In some examples, the message received from the network entity 105 is also indicative of a periodicity and a duration of the SRTC timing window within the S-SSB period. In some other examples, parameters included in the SRTC may be preconfigured at the UE 115-c.

At 610, the UE 115-c may identify the SRTC window for transmitting S-SSBs based on the received SRTC. The UE 115-c may identify that the SRTC includes more S-SSB transmission occasions than the number of configured repetitions of the S-SSB. The SRTC window may be located at a configured offset from the beginning of an S-SSB period as indicated by the SRTC, and the UE 115-c may participate in the at least one LBT procedure in accordance with the offset. In some examples, the SRTC window may be further configured by a periodicity that is equal to the periodicity of the S-SSB period (e.g., 160 ms), or a periodicity that is equal to the periodicity of the S-SSB period divided by a quantity of the multiple S-SSB transmission occasions within the S-SSB period. In some examples, the duration of the SRTC window may be greater than a length of the number of configured repetitions of the S-SSB within the S-SSB period.

In some examples, the SRTC may include information indicative of a slot index configuration for each of the one or more instances of the S-SSB, where the slot index configuration includes a common portion (e.g., common MSBs) for each of the one or more instances of the S-SSB. In some implementations, the slot index configuration may include a set of slot indices for identifying multiple slot locations corresponding to the one or more instances of the S-SSB, and each slot index of the set of slot indices may include multiple MSBs and LSBs, and a toggle bit.

In some cases, the UE 115-c may identify a timing difference between the first slot index and the later slot index based on the toggle bit of the first slot index being different from the toggle bit of the later slot index, or based on a single bit of the multiple MSBs of the first slot index being different from a single bit of the multiple MSBs of the later slot index. In some cases, the value of the multiple MSBs may be the same for different slot indices. In some examples, the value of the toggle bit is changed at a boundary of a subset of the multiple slot locations corresponding to the one or more instances of the S-SSB, and the change in the toggle bit indicates a first repetition of least significant bit (LSB) values corresponding to slot indices of the subset of the multiple slot locations.

In some other examples, the slot index configuration may indicate a value of a slot offset and a repetition index within the S-SSB period, and the UE 115-c may identify multiple slot locations for transmission of the one or more instances of the S-SSB based on the offset and repetition index. In some cases, the slot offset may indicate a time duration between a beginning of a frame and a first transmitted S-SSB of the one or more instances of the S-SSB. The slot offset may be further based on successfully performing one or more LBT procedures for transmitting the S-SSBs. In some cases, the repetition index may indicate slot indices of the multiple slot locations within the S-SSB period, and the UE 115-c may determine the multiple slot locations based on a DFN, an SFN, the slot offset, the repetition index, or any combination thereof.

At 615, the UE 115-c may participate in at least one LBT procedure during the duration of the SRTC timing window. In some examples, the multiple S-SSB transmission occasions provided by the SRTC may be more numerous than a number of configured repetitions of a S-SSB within the timing window in order to compensate for possible failures of a portion of the at least one LBT procedure. In some examples, the UE 115-c may determine that at least one LBT procedure has failed during a first LBT occasion of the SRTC timing window. In such cases, the UE 115-c may participate in at least a second LBT procedure in a second LBT occasion following the first LBT occasion of the SRTC timing window. where the duration of the SRTC timing window is sufficient to allow the number of configured repetitions of the S-SSB to be transmitted despite the failure of the first LBT procedure.

At 620, the UE 115-d may monitor a sidelink channel for the S-SSBs. In some examples, the UE 115-d may monitor the sidelink channel in accordance with the timing window configured by the SRTC. In some other cases, the UE 115-d may receive, within the one or more S-SSBs, information indicative of the slot index configuration for each of the one or more S-SSBs.

At 625, the UE 115-c may transmit one or more instances of the S-SSB in accordance with the SRTC and based on an outcome of the at least one LBT procedure. In some cases, the UE 115-c may transmit the one or more instances of the S-SSB consecutively in the SRTC window within the S-SSB period.

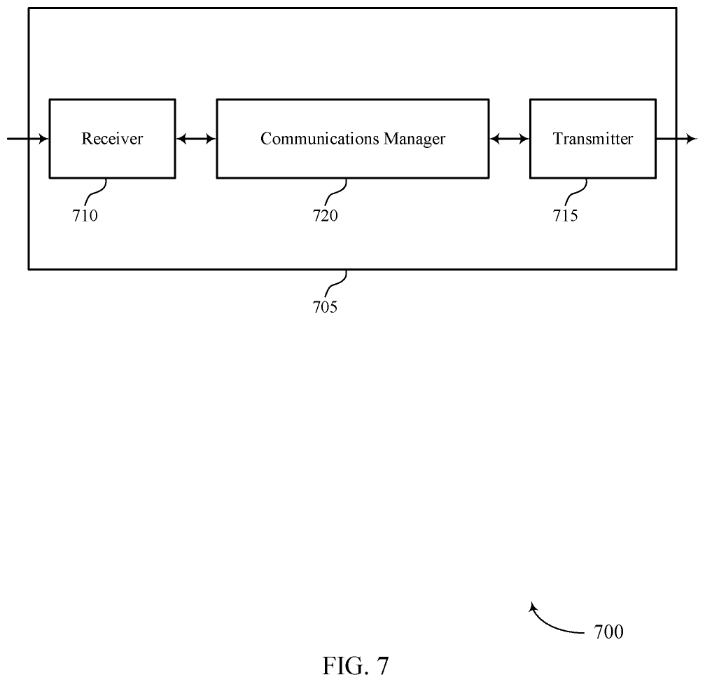

FIG. 7 shows a block diagram 700 of a device 705 that supports floating S-SSB for time domain repetition in accordance with one or more aspects of the present disclosure. The device 705 may be an example of aspects of a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to floating S-SSB for time domain repetition in high frequency bands). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to floating S-SSB for time domain repetition in high frequency bands). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations thereof or various components thereof may be examples of means for performing various aspects of floating S-SSB for time domain repetition in high frequency bands as described herein. For example, the communications manager 720, the receiver 710, the transmitter 715, or various combinations or components thereof may support a method for performing one or more of the functions described herein.

In some examples, the communications manager 720, the receiver 710, the transmitter 715, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 720, the receiver 710, the transmitter 715, or various combinations or components thereof may be implemented in code (e.g., as communications management software or firmware) executed by a processor. If implemented in code executed by a processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communication in accordance with examples as disclosed herein. For example, the communications manager 720 may be configured as or otherwise support a means for receiving, from a network entity, a message indicating a S-SSB timing configuration for a timing window that includes multiple S-SSB transmission occasions and that is within a S-SSB period, the message also indicative of a periodicity and a duration of the timing window within the S-SSB period. The communications manager 720 may be configured as or otherwise support a means for participating in at least one LBT procedure during the duration of the timing window, the multiple S-SSB transmission occasions provided by the S-SSB timing configuration being more numerous than a number of configured repetitions of a S-SSB within the timing window in order to compensate for failure of a portion of the at least one LBT procedure. The communications manager 720 may be configured as or otherwise support a means for transmitting one or more instances of the S-SSB in accordance with the S-SSB timing configuration and an outcome of the at least one LBT procedure.

Additionally, or alternatively, the communications manager 720 may support wireless communication in accordance with examples as disclosed herein. For example, the communications manager 720 may be configured as or otherwise support a means for receiving one or more S-SSBs within a timing window that includes multiple S-SSB reception occasions and that is within a S-SSB period. The communications manager 720 may be configured as or otherwise support a means for receiving, within the one or more S-SSBs, information indicative of a slot index configuration for each of the one or more S-SSBs, where the slot index configuration includes a portion that is common for each of the one or more S-SSBs.

By including or configuring the communications manager 720 in accordance with examples as described herein, the device 705 (e.g., a processor controlling or otherwise coupled with the receiver 710, the transmitter 715, the communications manager 720, or a combination thereof) may support techniques for reduced processing, more efficient utilization of communication resources, increased timing accuracy for transmitting and receiving sidelink communications, and increased signal strength.

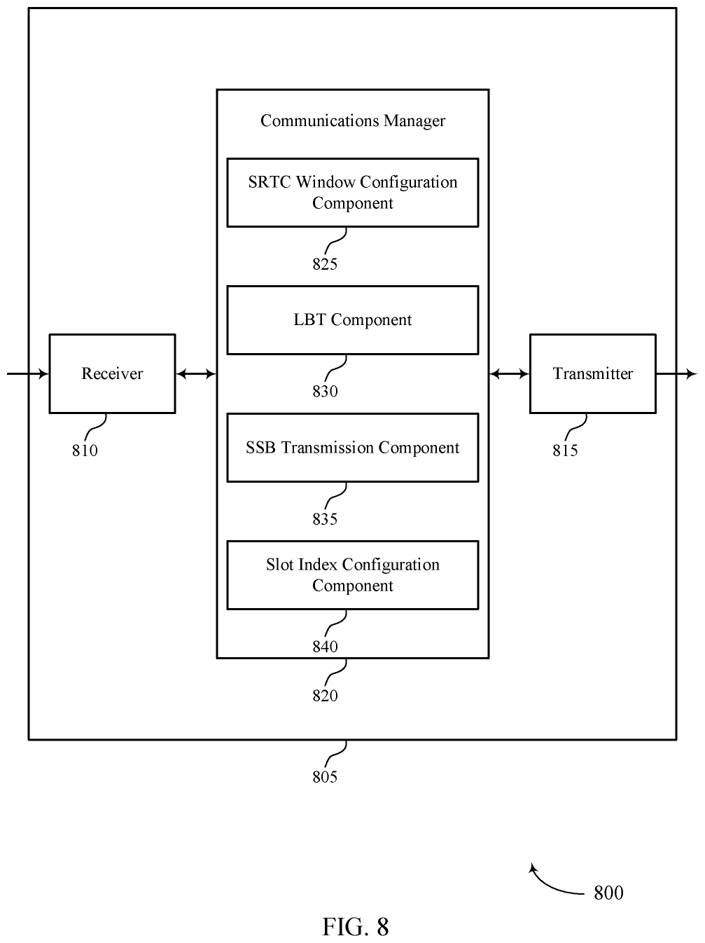

FIG. 8 shows a block diagram 800 of a device 805 that supports floating S-SSB for time domain repetition in accordance with one or more aspects of the present disclosure. The device 805 may be an example of aspects of a device 705 or a UE 115 as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to floating S-SSB for time domain repetition in high frequency bands). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to floating S-SSB for time domain repetition in high frequency bands). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of floating S-SSB for time domain repetition in high frequency bands as described herein. For example, the communications manager 820 may include an SRTC window configuration component 825, an LBT component 830, an SSB transmission component 835, a slot index configuration component 840, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communication in accordance with examples as disclosed herein. The SRTC window configuration component 825 may be configured as or otherwise support a means for receiving, from a network entity, a message indicating a S-SSB timing configuration for a timing window that includes multiple S-SSB transmission occasions and that is within a S-SSB period, the message also indicative of a periodicity and a duration of the timing window within the S-SSB period. The LBT component 830 may be configured as or otherwise support a means for participating in at least one LBT procedure during the duration of the timing window, the multiple S-SSB transmission occasions provided by the S-SSB timing configuration being more numerous than a number of configured repetitions of a S-SSB within the timing window in order to compensate for failure of a portion of the at least one LBT procedure. The SSB transmission component 835 may be configured as or otherwise support a means for transmitting one or more instances of the S-SSB in accordance with the S-SSB timing configuration and an outcome of the at least one LBT procedure.

Additionally, or alternatively, the communications manager 820 may support wireless communication in accordance with examples as disclosed herein. The SRTC window configuration component 825 may be configured as or otherwise support a means for receiving one or more S-SSBs within a timing window that includes multiple S-SSB reception occasions and that is within a S-SSB period. The slot index configuration component 840 may be configured as or otherwise support a means for receiving, within the one or more S-SSBs, information indicative of a slot index configuration for each of the one or more S-SSBs, where the slot index configuration includes a portion that is common for each of the one or more S-SSBs.

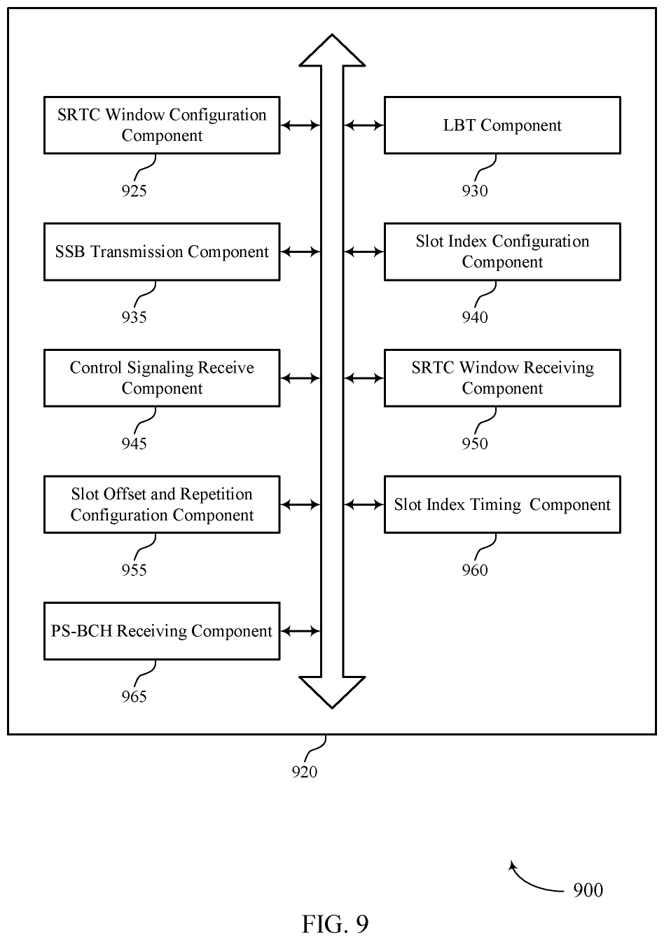

FIG. 9 shows a block diagram 900 of a communications manager 920 that supports floating S-SSB for time domain repetition in accordance with one or more aspects of the present disclosure. The communications manager 920 may be an example of aspects of a communications manager 720, a communications manager 820, or both, as described herein. The communications manager 920, or various components thereof, may be an example of means for performing various aspects of floating S-SSB for time domain repetition in high frequency bands as described herein. For example, the communications manager 920 may include an SRTC window configuration component 925, an LBT component 930, an SSB transmission component 935, a slot index configuration component 940, a control signaling receive component 945, an SRTC window receiving component 950, a slot offset and repetition configuration component 955, a slot index timing component 960, a PS-BCH receiving component 965, or any combination thereof. Each of these components may communicate, directly or indirectly, with one another (e.g., via one or more buses).

The communications manager 920 may support wireless communication in accordance with examples as disclosed herein. The SRTC window configuration component 925 may be configured as or otherwise support a means for receiving, from a network entity, a message indicating a S-SSB timing configuration for a timing window that includes multiple S-SSB transmission occasions and that is within a S-SSB period, the message also indicative of a periodicity and a duration of the timing window within the S-SSB period. The LBT component 930 may be configured as or otherwise support a means for participating in at least one LBT procedure during the duration of the timing window; the multiple S-SSB transmission occasions provided by the S-SSB timing configuration being more numerous than a number of configured repetitions of a S-SSB within the timing window in order to compensate for failure of a portion of the at least one LBT procedure. The SSB transmission component 935 may be configured as or otherwise support a means for transmitting one or more instances of the S-SSB in accordance with the S-SSB timing configuration and an outcome of the at least one LBT procedure.

In some examples, the LBT component 930 may be configured as or otherwise support a means for determining a failure of a first LBT procedure during a first LBT occasion of the timing window. In some examples, the LBT component 930 may be configured as or otherwise support a means for participating in at least a second LBT procedure in a second LBT occasion following the first LBT occasion of the timing window based on the duration, where the duration of the timing window is sufficient to allow the number of configured repetitions of the S-SSB to be transmitted despite the failure of the first LBT procedure.

In some examples, to support receiving the message indicating a S-SSB timing configuration, the SRTC window configuration component 925 may be configured as or otherwise support a means for identifying that the S-SSB timing configuration includes more S-SSB transmission occasions than the number of configured repetitions of the S-SSB.

In some examples, the S-SSB timing configuration further indicates a value for an offset, and the LBT component 930 may be configured as or otherwise support a means for participating in a first LBT procedure at a first S-SSB occasion of the timing window, where the value for the offset indicates a timing for the first S-SSB occasion relative to a beginning of the S-SSB period.

In some examples, to support transmitting the one or more instances of the S-SSB, the SSB transmission component 935 may be configured as or otherwise support a means for transmitting the one or more instances of the S-SSB consecutively in the timing window within the S-SSB period.

In some examples, the periodicity of the timing window is equal to a periodicity of the S-SSB period.

In some examples, the periodicity of the timing window includes 160 milliseconds.

In some examples, the periodicity of the timing window is equal to a periodicity of the S-SSB period divided by a quantity of bursts of the multiple S-SSB transmission occasions within the S-SSB period.

In some examples, the duration is greater than a length of the number of configured repetitions of the S-SSB within the S-SSB period.

In some examples, the control signaling receive component 945 may be configured as or otherwise support a means for receiving, from the network entity, a radio resource control message that indicates the S-SSB timing configuration.

In some examples, the S-SSB timing configuration, the periodicity, the duration of the timing window, or any combination thereof, are preconfigured at the UE.

In some examples, the slot index configuration component 940 may be configured as or otherwise support a means for including, within the one or more instances of the S-SSB, information indicative of a slot index configuration for each of the one or more instances of the S-SSB, where the slot index configuration includes a common portion for each of the one or more instances of the S-SSB.

In some examples, the slot index configuration component 940 may be configured as or otherwise support a means for determining, in accordance with the slot index configuration, a set of slot indices for identifying multiple slot locations corresponding to the one or more instances of the S-SSB, where each slot index of the set of slot indices include multiple most significant bits, multiple least significant bits, and a toggle bit.

In some examples, a value of the multiple least significant bits for a first slot index is equal to a value of the multiple least significant bits at a later slot index, and the slot index timing component 960 may be configured as or otherwise support a means for identifying a timing difference between the first slot index and the later slot index based on the toggle bit of the first slot index being different from the toggle bit of the later slot index.

In some examples, a value of the multiple least significant bits for a first slot index is equal to a value of the multiple least significant bits at a later slot index, and the slot index timing component 960 may be configured as or otherwise support a means for identifying a timing difference between the first slot index and the later slot index based on a single bit of the multiple most significant bits of the first slot index being different from a single bit of the multiple most significant bits of the later slot index.

In some examples, a value of the toggle bit is changed at a boundary of a subset of the multiple slot locations corresponding to the one or more instances of the S-SSB, the change in the toggle bit indicating a first repetition of multiple least significant bit values corresponding to slot indices of the subset of the multiple slot locations.

In some examples, the PS-BCH receiving component 965 may be configured as or otherwise support a means for receiving the multiple most significant bits, the multiple least significant bits, and the toggle bit in a sidelink broadcast channel.

In some examples, the slot index configuration component 940 may be configured as or otherwise support a means for determining a first set of most significant bits of the multiple most significant bits associated with a first slot index of a first synchronization signal block. In some examples, the slot index configuration component 940 may be configured as or otherwise support a means for determining respective sets of most significant bits of the multiple most significant bits associated with slot indices that follow the first slot index, where the respective sets of most significant bits have a same value as the first set of most significant bits.

In some examples, the slot index configuration further indicates a value for an offset and a repetition index within the S-SSB period, and the slot offset and repetition configuration component 955 may be configured as or otherwise support a means for transmitting a first set of bits corresponding to the offset and a second set of bits corresponding to the repetition index. In some examples, the slot index configuration further indicates a value for an offset and a repetition index within the S-SSB period, and the slot offset and repetition configuration component 955 may be configured as or otherwise support a means for identifying multiple slot locations corresponding to the one or more instances of the S-SSB based on the offset and the repetition index.

In some examples, the offset includes a time duration between a beginning of a frame and a first transmitted S-SSB of the one or more instances of the S-SSB.

In some examples, the offset is based on successfully performing the at least one LBT procedure.

In some examples, the repetition index indicates slot indices of the multiple slot locations within the S-SSB period.

In some examples, the slot index configuration component 940 may be configured as or otherwise support a means for determining the multiple slot locations based on a direct frame number, a system frame number, the offset, the repetition index, or any combination thereof.

Additionally, or alternatively, the communications manager 920 may support wireless communication in accordance with examples as disclosed herein. In some examples, the SRTC window configuration component 925 may be configured as or otherwise support a means for receiving one or more S-SSBs within a timing window that includes multiple S-SSB reception occasions and that is within a S-SSB period. The slot index configuration component 940 may be configured as or otherwise support a means for receiving, within the one or more S-SSBs, information indicative of a slot index configuration for each of the one or more S-SSBs, where the slot index configuration includes a portion that is common for each of the one or more S-SSBs.

In some examples, to support receiving the one or more S-SSBs, the SRTC window receiving component 950 may be configured as or otherwise support a means for receiving the one or more S-SSBs consecutively in the timing window within the S-SSB period.

In some examples, a periodicity of the timing window is equal to a periodicity of the S-SSB period or to a periodicity of the S-SSB period divided by a quantity of the multiple S-SSB reception occasions within the S-SSB period.

In some examples, the duration is greater than a length of the number of configured repetitions of the S-SSB within the S-SSB period.

In some examples, the slot index configuration component 940 may be configured as or otherwise support a means for determining, in accordance with the slot index configuration, a set of slot indices for identifying multiple slot locations corresponding to the one or more S-SSBs, where each slot index of the set of slot indices include multiple most significant bits, multiple least significant bits, and a toggle bit

In some examples, a value of the multiple least significant bits for a first slot index is equal to a value of the multiple least significant bits at a later slot index, and the slot index timing component 960 may be configured as or otherwise support a means for identifying a timing difference between the first slot index and the later slot index based on the toggle bit of the first slot index being different from the toggle bit of the later slot index.

In some examples, a value of the multiple least significant bits for a first slot index is equal to a value of the multiple least significant bits at a later slot index, and the slot index timing component 960 may be configured as or otherwise support a means for identifying a timing difference between the first slot index and the later slot index based on a single bit of the multiple most significant bits of the first slot index being different from a single bit of the multiple most significant bits of the later slot index.

In some examples, a value of the toggle bit is changed at a boundary of a subset of the multiple slot locations corresponding to the one or more S-SSBs, the change in the toggle bit indicating a first repetition of multiple least significant bit values corresponding to slot indices of the subset of the multiple slot locations.

In some examples, the slot index configuration further indicates a value for an offset and a repetition index within the S-SSB period, and the slot offset and repetition configuration component 955 may be configured as or otherwise support a means for receiving a first set of bits corresponding to the offset and a second set of bits corresponding to the repetition index. In some examples, the slot index configuration further indicates a value for an offset and a repetition index within the S-SSB period, and the slot offset and repetition configuration component 955 may be configured as or otherwise support a means for identifying multiple slot locations corresponding to the one or more instances of the S-SSB based on the offset and the repetition index.

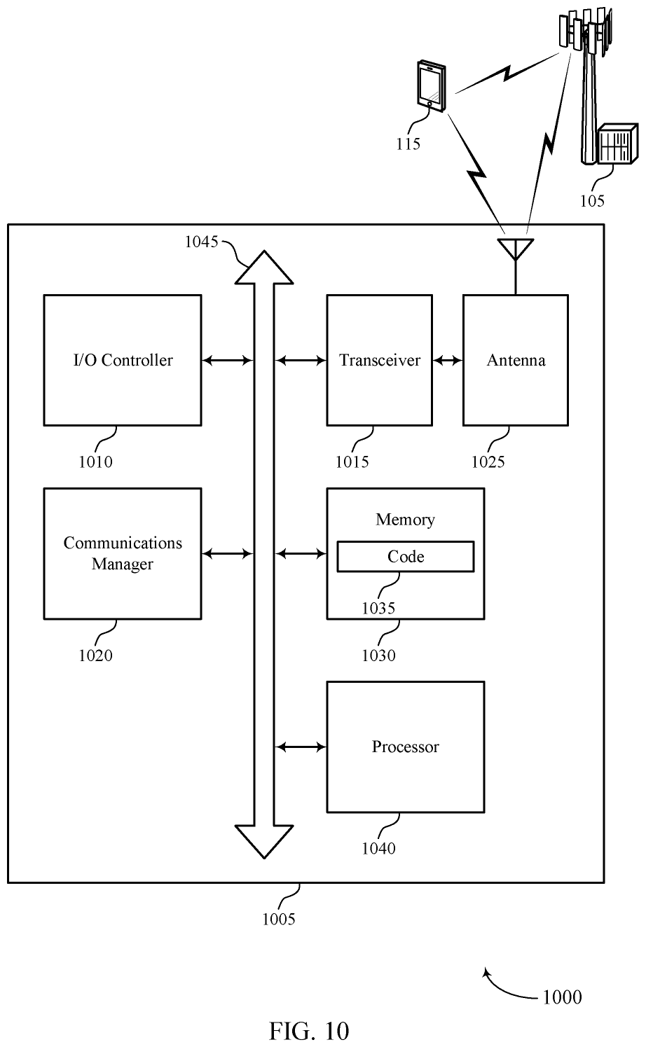

FIG. 10 shows a diagram of a system 1000 including a device 1005 that supports floating S-SSB for time domain repetition in accordance with one or more aspects of the present disclosure. The device 1005 may be an example of or include the components of a device 705, a device 805, or a UE 115 as described herein. The device 1005 may communicate (e.g., wirelessly) with one or more network entities 105, one or more UEs 115, or any combination thereof. The device 1005 may include components for bi-directional voice and data communications including components for transmitting and receiving communications, such as a communications manager 1020, an input/output (I/O) controller 1010, a transceiver 1015, an antenna 1025, a memory 1030, code 1035, and a processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally or alternatively, the I/O controller 1010 may represent or interact with a modem, a keyboard, a mouse, a touchscreen, or a similar device. In some cases, the I/O controller 1010 may be implemented as part of a processor, such as the processor 1040. In some cases, a user may interact with the device 1005 via the I/O controller 1010 or via hardware components controlled by the I/O controller 1010.

In some cases, the device 1005 may include a single antenna 1025. However, in some other cases, the device 1005 may have more than one antenna 1025, which may be capable of concurrently transmitting or receiving multiple wireless transmissions. The transceiver 1015 may communicate bi-directionally, via the one or more antennas 1025, wired, or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The memory 1030 may include random access memory (RAM) and read-only memory (ROM). The memory 1030 may store computer-readable, computer-executable code 1035 including instructions that, when executed by the processor 1040, cause the device 1005 to perform various functions described herein. The code 1035 may be stored in a non-transitory computer-readable medium such as system memory or another type of memory. In some cases, the code 1035 may not be directly executable by the processor 1040 but may cause a computer (e.g., when compiled and executed) to perform functions described herein. In some cases, the memory 1030 may contain, among other things, a basic I/O system (BIOS) which may control basic hardware or software operation such as the interaction with peripheral components or devices.

The processor 1040 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1040 may be configured to operate a memory array using a memory controller. In some other cases, a memory controller may be integrated into the processor 1040. The processor 1040 may be configured to execute computer-readable instructions stored in a memory (e.g., the memory 1030) to cause the device 1005 to perform various functions (e.g., functions or tasks supporting floating S-SSB for time domain repetition in high frequency bands). For example, the device 1005 or a component of the device 1005 may include a processor 1040 and memory 1030 coupled with or to the processor 1040, the processor 1040 and memory 1030 configured to perform various functions described herein.

The communications manager 1020 may support wireless communication in accordance with examples as disclosed herein. For example, the communications manager 1020 may be configured as or otherwise support a means for receiving, from a network entity, a message indicating a S-SSB timing configuration for a timing window that includes multiple S-SSB transmission occasions and that is within a S-SSB period, the message also indicative of a periodicity and a duration of the timing window within the S-SSB period. The communications manager 1020 may be configured as or otherwise support a means for participating in at least one LBT procedure during the duration of the timing window, the multiple S-SSB transmission occasions provided by the S-SSB timing configuration being more numerous than a number of configured repetitions of a S-SSB within the timing window in order to compensate for failure of a portion of the at least one LBT procedure. The communications manager 1020 may be configured as or otherwise support a means for transmitting one or more instances of the S-SSB in accordance with the S-SSB timing configuration and an outcome of the at least one LBT procedure.

Additionally, or alternatively, the communications manager 1020 may support wireless communication in accordance with examples as disclosed herein. For example, the communications manager 1020 may be configured as or otherwise support a means for receiving one or more S-SSBs within a timing window that includes multiple S-SSB reception occasions and that is within a S-SSB period. The communications manager 1020 may be configured as or otherwise support a means for receiving, within the one or more S-SSBs, information indicative of a slot index configuration for each of the one or more S-SSBs, where the slot index configuration includes a portion that is common for each of the one or more S-SSBs.

By including or configuring the communications manager 1020 in accordance with examples as described herein, the device 1005 may support techniques for improved communication reliability, reduced power consumption, more efficient utilization of communication resources, improved coordination between devices, improved utilization of processing capability, increased timing accuracy for transmitting and receiving sidelink communications, increased signal strength, and improved slot indexing and identification techniques.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the processor 1040, the memory 1030, the code 1035, or any combination thereof. For example, the code 1035 may include instructions executable by the processor 1040 to cause the device 1005 to perform various aspects of floating S-SSB for time domain repetition in high frequency bands as described herein, or the processor 1040 and the memory 1030 may be otherwise configured to perform or support such operations.

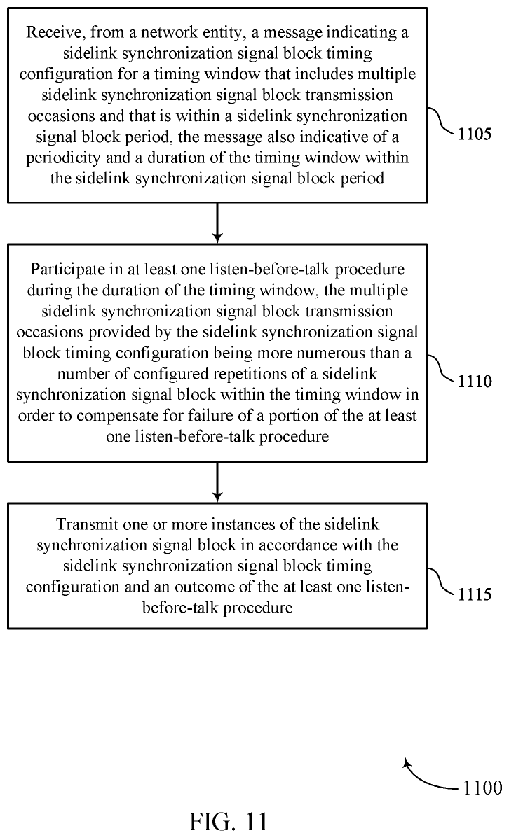

FIG. 11 shows a flowchart illustrating a method 1100 that supports floating S-SSB for time domain repetition in accordance with one or more aspects of the present disclosure. The operations of the method 1100 may be implemented by a UE or its components as described herein. For example, the operations of the method 1100 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1105, the method may include receiving, from a network entity, a message indicating a S-SSB timing configuration for a timing window that includes multiple S-SSB transmission occasions and that is within a S-SSB period, the message also indicative of a periodicity and a duration of the timing window within the S-SSB period. The operations of 1105 may be performed in accordance with examples as disclosed herein. In some examples, aspects of the operations of 1105 may be performed by an SRTC window configuration component 925 as described with reference to FIG. 9.

At 1110, the method may include participating in at least one LBT procedure during the duration of the timing window, the multiple S-SSB transmission occasions provided by the S-SSB timing configuration being more numerous than a number of configured repetitions of a S-SSB within the timing window in order to compensate for failure of a portion of the at least one LBT procedure. The operations of 1110 may be performed in accordance with examples as disclosed herein. In some examples, aspects of the operations of 1110 may be performed by an LBT component 930 as described with reference to FIG. 9.

At 1115, the method may include transmitting one or more instances of the S-SSB in accordance with the S-SSB timing configuration and an outcome of the at least one LBT procedure. The operations of 1115 may be performed in accordance with examples as disclosed herein. In some examples, aspects of the operations of 1115 may be performed by an SSB transmission component 935 as described with reference to FIG. 9.

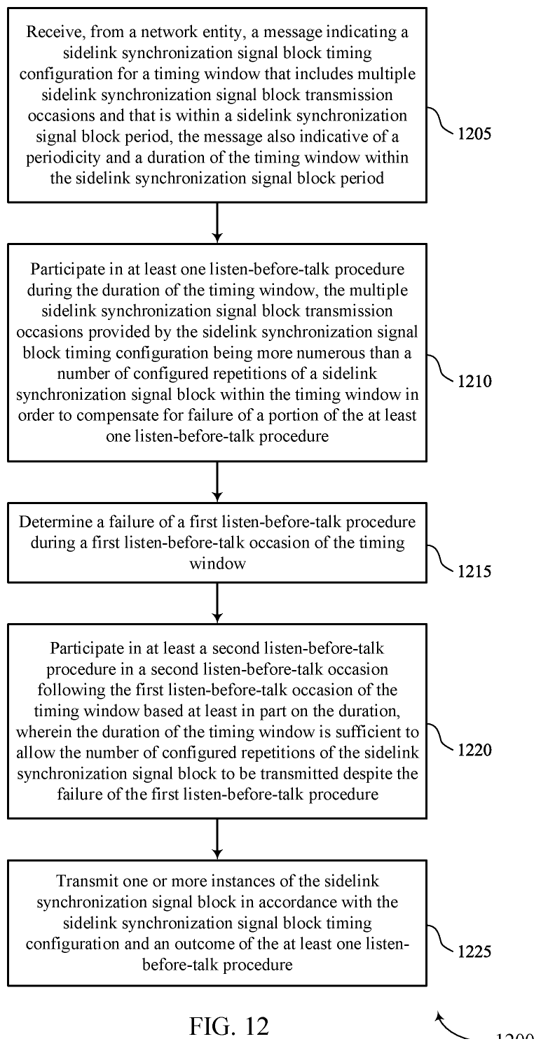

FIG. 12 shows a flowchart illustrating a method 1200 that supports floating S-SSB for time domain repetition in accordance with one or more aspects of the present disclosure. The operations of the method 1200 may be implemented by a UE or its components as described herein. For example, the operations of the method 1200 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1205, the method may include receiving, from a network entity, a message indicating a S-SSB timing configuration for a timing window that includes multiple S-SSB transmission occasions and that is within a S-SSB period, the message also indicative of a periodicity and a duration of the timing window within the S-SSB period. The operations of 1205 may be performed in accordance with examples as disclosed herein. In some examples, aspects of the operations of 1205 may be performed by an SRTC window configuration component 925 as described with reference to FIG. 9.

At 1210, the method may include participating in at least one LBT procedure during the duration of the timing window, the multiple S-SSB transmission occasions provided by the S-SSB timing configuration being more numerous than a number of configured repetitions of a S-SSB within the timing window in order to compensate for failure of a portion of the at least one LBT procedure. The operations of 1210 may be performed in accordance with examples as disclosed herein. In some examples, aspects of the operations of 1210 may be performed by an LBT component 930 as described with reference to FIG. 9.

At 1215, the method may include determining a failure of a first LBT procedure during a first LBT occasion of the timing window. The operations of 1215 may be performed in accordance with examples as disclosed herein. In some examples, aspects of the operations of 1215 may be performed by an LBT component 930 as described with reference to FIG. 9.

At 1220, the method may include participating in at least a second LBT procedure in a second LBT occasion following the first LBT occasion of the timing window based on the duration, where the duration of the timing window is sufficient to allow the number of configured repetitions of the S-SSB to be transmitted despite the failure of the first LBT procedure. The operations of 1220 may be performed in accordance with examples as disclosed herein. In some examples, aspects of the operations of 1220 may be performed by an LBT component 930 as described with reference to FIG. 9.

At 1225, the method may include transmitting one or more instances of the S-SSB in accordance with the S-SSB timing configuration and an outcome of the at least one LBT procedure. The operations of 1225 may be performed in accordance with examples as disclosed herein. In some examples, aspects of the operations of 1225 may be performed by an SSB transmission component 935 as described with reference to FIG. 9.

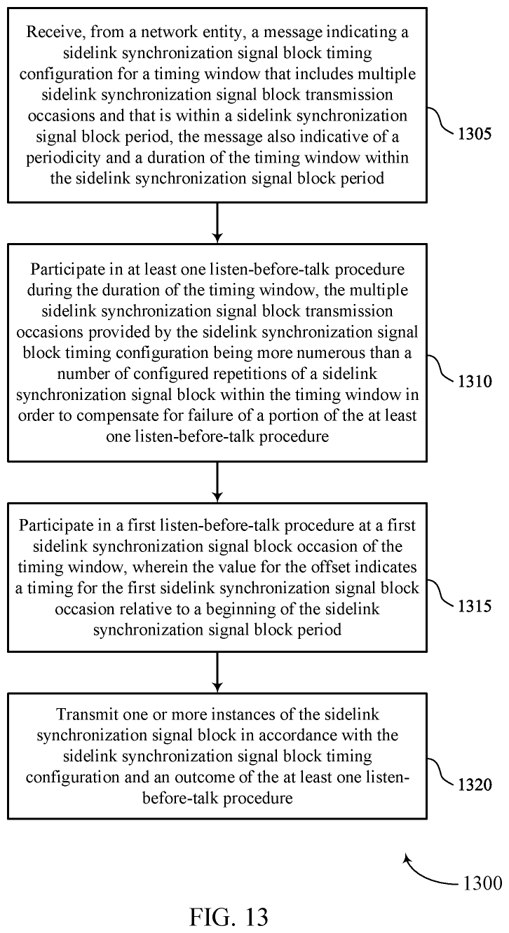

FIG. 13 shows a flowchart illustrating a method 1300 that supports floating S-SSB for time domain repetition in accordance with one or more aspects of the present disclosure. The operations of the method 1300 may be implemented by a UE or its components as described herein. For example, the operations of the method 1300 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1305, the method may include receiving, from a network entity, a message indicating a S-SSB timing configuration for a timing window that includes multiple S-SSB transmission occasions and that is within a S-SSB period, the message also indicative of a periodicity and a duration of the timing window within the S-SSB period. The operations of 1305 may be performed in accordance with examples as disclosed herein. In some examples, aspects of the operations of 1305 may be performed by an SRTC window configuration component 925 as described with reference to FIG. 9.

At 1310, the method may include participating in at least one LBT procedure during the duration of the timing window, the multiple S-SSB transmission occasions provided by the S-SSB timing configuration being more numerous than a number of configured repetitions of a S-SSB within the timing window in order to compensate for failure of a portion of the at least one LBT procedure. The operations of 1310 may be performed in accordance with examples as disclosed herein. In some examples, aspects of the operations of 1310 may be performed by an LBT component 930 as described with reference to FIG. 9.

At 1315, the method may include participating in a first LBT procedure at a first S-SSB occasion of the timing window, where the value for the offset indicates a timing for the first S-SSB occasion relative to a beginning of the S-SSB period. The operations of 1315 may be performed in accordance with examples as disclosed herein. In some examples, aspects of the operations of 1315 may be performed by an LBT component 930 as described with reference to FIG. 9.

At 1320, the method may include transmitting one or more instances of the S-SSB in accordance with the S-SSB timing configuration and an outcome of the at least one LBT procedure. The operations of 1320 may be performed in accordance with examples as disclosed herein. In some examples, aspects of the operations of 1320 may be performed by an SSB transmission component 935 as described with reference to FIG. 9.

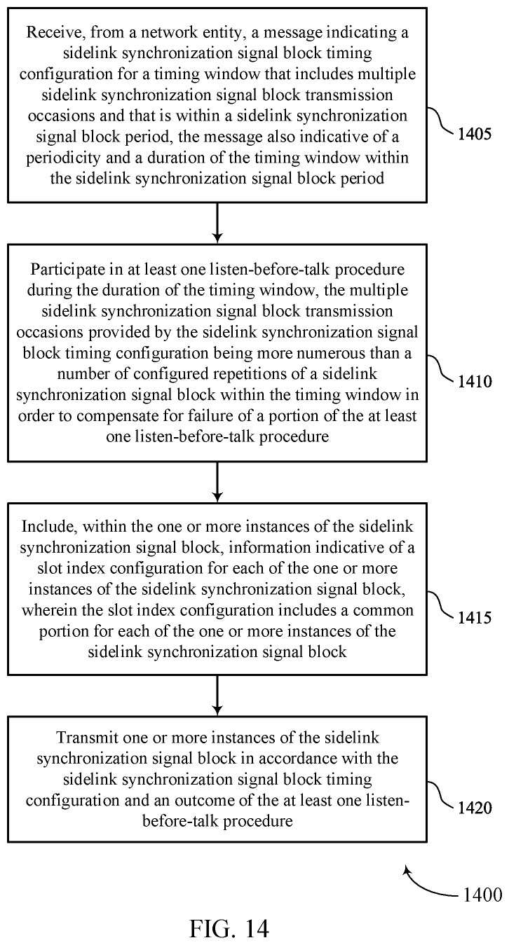

FIG. 14 shows a flowchart illustrating a method 1400 that supports floating S-SSB for time domain repetition in accordance with one or more aspects of the present disclosure. The operations of the method 1400 may be implemented by a UE or its components as described herein. For example, the operations of the method 1400 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1405, the method may include receiving, from a network entity, a message indicating a S-SSB timing configuration for a timing window that includes multiple S-SSB transmission occasions and that is within a S-SSB period, the message also indicative of a periodicity and a duration of the timing window within the S-SSB period. The operations of 1405 may be performed in accordance with examples as disclosed herein. In some examples, aspects of the operations of 1405 may be performed by an SRTC window configuration component 925 as described with reference to FIG. 9.

At 1410, the method may include participating in at least one LBT procedure during the duration of the timing window, the multiple S-SSB transmission occasions provided by the S-SSB timing configuration being more numerous than a number of configured repetitions of a S-SSB within the timing window in order to compensate for failure of a portion of the at least one LBT procedure. The operations of 1410 may be performed in accordance with examples as disclosed herein. In some examples, aspects of the operations of 1410 may be performed by an LBT component 930 as described with reference to FIG. 9.

At 1415, the method may include including, within the one or more instances of the S-SSB, information indicative of a slot index configuration for each of the one or more instances of the S-SSB, where the slot index configuration includes a common portion for each of the one or more instances of the S-SSB. The operations of 1415 may be performed in accordance with examples as disclosed herein. In some examples, aspects of the operations of 1415 may be performed by a slot index configuration component 940 as described with reference to FIG. 9.

At 1420, the method may include transmitting one or more instances of the S-SSB in accordance with the S-SSB timing configuration and an outcome of the at least one LBT procedure. The operations of 1420 may be performed in accordance with examples as disclosed herein. In some examples, aspects of the operations of 1420 may be performed by an SSB transmission component 935 as described with reference to FIG. 9.

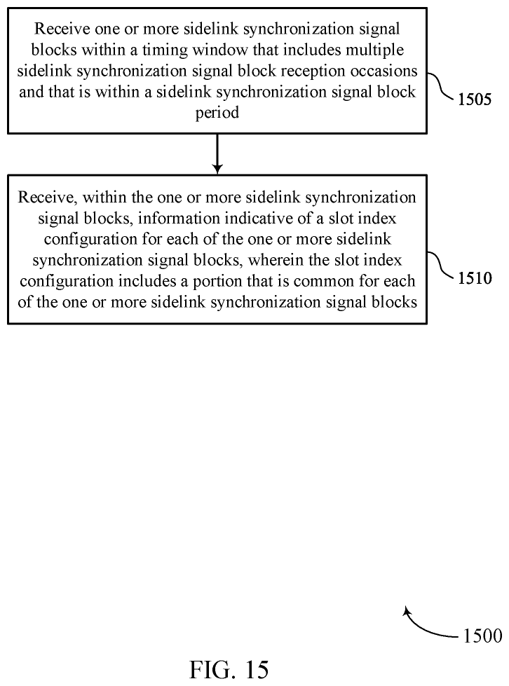

FIG. 15 shows a flowchart illustrating a method 1500 that supports floating S-SSB for time domain repetition in accordance with one or more aspects of the present disclosure. The operations of the method 1500 may be implemented by a UE or its components as described herein. For example, the operations of the method 1500 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1505, the method may include receiving one or more S-SSBs within a timing window that includes multiple S-SSB reception occasions and that is within a S-SSB period. The operations of 1505 may be performed in accordance with examples as disclosed herein. In some examples, aspects of the operations of 1505 may be performed by an SRTC window configuration component 925 as described with reference to FIG. 9.

At 1510, the method may include receiving, within the one or more S-SSBs, information indicative of a slot index configuration for each of the one or more S-SSBs, where the slot index configuration includes a portion that is common for each of the one or more S-SSBs. The operations of 1510 may be performed in accordance with examples as disclosed herein. In some examples, aspects of the operations of 1510 may be performed by a slot index configuration component 940 as described with reference to FIG. 9.

The following provides an overview of aspects of the present disclosure:

Aspect 1: A method for wireless communication, comprising: receiving, from a network entity, a message indicating a S-SSB timing configuration for a timing window that includes multiple S-SSB transmission occasions and that is within a S-SSB period, the message also indicative of a periodicity and a duration of the timing window within the S-SSB period: participating in at least one LBT procedure during the duration of the timing window; the multiple S-SSB transmission occasions provided by the S-SSB timing configuration being more numerous than a number of configured repetitions of a S-SSB within the timing window in order to compensate for failure of a portion of the at least one LBT procedure: and transmitting one or more instances of the S-SSB in accordance with the S-SSB timing configuration and an outcome of the at least one LBT procedure.

Aspect 2: The method of aspect 1, further comprising: determining a failure of a first LBT procedure during a first LBT occasion of the timing window; and participating in at least a second LBT procedure in a second LBT occasion following the first LBT occasion of the timing window based at least in part on the duration, wherein the duration of the timing window is sufficient to allow the number of configured repetitions of the S-SSB to be transmitted despite the failure of the first LBT procedure.

Aspect 3: The method of any of aspects 1 through 2, wherein receiving the message indicating the S-SSB timing configuration further comprises: identifying that the S-SSB timing configuration includes more S-SSB transmission occasions than the number of configured repetitions of the S-SSB.

Aspect 4: The method of any of aspects 1 through 3, wherein the S-SSB timing configuration further indicates a value for an offset, the method further comprising: participating in a first LBT procedure at a first S-SSB occasion of the timing window, wherein the value for the offset indicates a timing for the first S-SSB occasion relative to a beginning of the S-SSB period.

Aspect 5: The method of any of aspects 1 through 4, wherein transmitting the one or more instances of the S-SSB comprises: transmitting the one or more instances of the S-SSB consecutively in the timing window within the S-SSB period.

Aspect 6: The method of any of aspects 1 through 5, wherein the periodicity of the timing window is equal to a periodicity of the S-SSB period.

Aspect 7: The method of aspect 6, wherein the periodicity of the timing window comprises 160 milliseconds.

Aspect 8: The method of any of aspects 1 through 7, wherein the periodicity of the timing window is equal to a periodicity of the S-SSB period divided by a quantity of bursts of the multiple S-SSB transmission occasions within the S-SSB period.

Aspect 9: The method of any of aspects 1 through 8, wherein the duration is greater than a length of the number of configured repetitions of the S-SSB within the S-SSB period.

Aspect 10: The method of any of aspects 1 through 9, further comprising: receiving, from the network entity, a radio resource control message that indicates the S-SSB timing configuration.

Aspect 11: The method of any of aspects 1 through 10, wherein the S-SSB timing configuration, the periodicity, the duration of the timing window, or any combination thereof, are preconfigured at the UE.

Aspect 12: The method of any of aspects 1 through 11, further comprising: including, within the one or more instances of the S-SSB, information indicative of a slot index configuration for each of the one or more instances of the S-SSB, wherein the slot index configuration includes a common portion for each of the one or more instances of the S-SSB.

Aspect 13: The method of aspect 12, further comprising: determining, in accordance with the slot index configuration, a set of slot indices for identifying multiple slot locations corresponding to the one or more instances of the S-SSB, wherein each slot index of the set of slot indices comprise multiple MSBs, multiple LSBs, and a toggle bit.

Aspect 14: The method of aspect 13, wherein a value of the multiple LSBs for a first slot index is equal to a value of the multiple LSBs at a later slot index, the method further comprising: identifying a timing difference between the first slot index and the later slot index based at least in part on the toggle bit of the first slot index being different from the toggle bit of the later slot index.

Aspect 15: The method of any of aspects 13 through 14, wherein a value of the multiple LSBs for a first slot index is equal to a value of the multiple LSBs at a later slot index, the method further comprising: identifying a timing difference between the first slot index and the later slot index based at least in part on a single bit of the multiple MSBs of the first slot index being different from a single bit of the multiple MSBs of the later slot index.

Aspect 16: The method of any of aspects 13 through 15, wherein a value of the toggle bit is changed at a boundary of a subset of the multiple slot locations corresponding to the one or more instances of the S-SSB, the change in the toggle bit indicating a first repetition of multiple least significant bit values corresponding to slot indices of the subset of the multiple slot locations.

Aspect 17: The method of any of aspects 13 through 16, further comprising: receiving the multiple MSBs, the multiple LSBs, and the toggle bit in a sidelink broadcast channel.

Aspect 18: The method of any of aspects 13 through 17, further comprising: determining a first set of MSBs of the multiple MSBs associated with a first slot index of a first SSB; and determining respective sets of MSBs of the multiple MSBs associated with slot indices that follow the first slot index, wherein the respective sets of MSBs have a same value as the first set of MSBs.

Aspect 19: The method of any of aspects 12 through 18, wherein the slot index configuration further indicates a value for an offset and a repetition index within the S-SSB period, the method further comprising: transmitting a first set of bits corresponding to the offset and a second set of bits corresponding to the repetition index: and identifying multiple slot locations corresponding to the one or more instances of the S-SSB based at least in part on the offset and the repetition index.

Aspect 20: The method of aspect 19, wherein the offset comprises a time duration between a beginning of a frame and a first transmitted S-SSB of the one or more instances of the S-SSB.

Aspect 21: The method of any of aspects 19 through 20, wherein the offset is based at least in part on successfully performing the at least one LBT procedure.

Aspect 22: The method of any of aspects 19 through 21, wherein the repetition index indicates slot indices of the multiple slot locations within the S-SSB period.

Aspect 23: The method of any of aspects 19 through 22, further comprising: determining the multiple slot locations based at least in part on a direct frame number, a system frame number, the offset, the repetition index, or any combination thereof.

Aspect 24: A method for wireless communication, comprising: receiving one or more S-SSBs within a timing window that includes multiple S-SSB reception occasions and that is within a S-SSB period: and receiving, within the one or more S-SSBs, information indicative of a slot index configuration for each of the one or more S-SSBs, wherein the slot index configuration includes a portion that is common for each of the one or more S-SSBs.

Aspect 25: The method of aspect 24, wherein a periodicity of the timing window is equal to a periodicity of the S-SSB period or to a periodicity of the S-SSB period divided by a quantity of the multiple S-SSB reception occasions within the S-SSB period.

Aspect 26: The method of any of aspects 24 through 25, further comprising: determining, in accordance with the slot index configuration, a set of slot indices for identifying multiple slot locations corresponding to the one or more S-SSBs, wherein each slot index of the set of slot indices comprise multiple MSBs, multiple LSBs, and a toggle bit: and identifying a timing difference between a first slot index and a later slot index based at least in part on the toggle bit of the first slot index being different from the toggle bit of the later slot index.

Aspect 27: The method of aspect 26, wherein a value of the multiple LSBs for the first slot index is equal to a value of the multiple LSBs at the later slot index, the method further comprising: identifying the timing difference between the first slot index and the later slot index based at least in part on a single bit of the multiple MSBs of the first slot index being different from a single bit of the multiple MSBs of the later slot index.

Aspect 28: The method of any of aspects 24 through 27, wherein the slot index configuration further indicates a value for an offset and a repetition index within the S-SSB period, the method further comprising: receiving a first set of bits corresponding to the offset and a second set of bits corresponding to the repetition index: and identifying multiple slot locations corresponding to the one or more S-SSBs based at least in part on the offset and the repetition index.

Aspect 29: An apparatus for wireless communication, comprising a processor: memory coupled with the processor; and instructions stored in the memory and executable by the processor to cause the apparatus to perform a method of any of aspects 1 through 23.

Aspect 30: An apparatus for wireless communication, comprising at least one means for performing a method of any of aspects 1 through 23.

Aspect 31: A non-transitory computer-readable medium storing code for wireless communication, the code comprising instructions executable by a processor to perform a method of any of aspects 1 through 23.

Aspect 32: An apparatus for wireless communication, comprising a processor: memory coupled with the processor: and instructions stored in the memory and executable by the processor to cause the apparatus to perform a method of any of aspects 24 through 28.

Aspect 33: An apparatus for wireless communication, comprising at least one means for performing a method of any of aspects 24 through 28.

Aspect 34: A non-transitory computer-readable medium storing code for wireless communication, the code comprising instructions executable by a processor to perform a method of any of aspects 24 through 28.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, obtaining, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communication, comprising:
receiving, from a network entity, a message indicating a sidelink synchronization signal block timing configuration for a timing window that includes multiple sidelink synchronization signal block transmission occasions and that is within a sidelink synchronization signal block period, the message also indicative of a periodicity and a duration of the timing window within the sidelink synchronization signal block period;
participating in at least one listen-before-talk procedure during the duration of the timing window, the multiple sidelink synchronization signal block transmission occasions provided by the sidelink synchronization signal block timing configuration being more numerous than a number of configured repetitions of a sidelink synchronization signal block within the timing window in order to compensate for failure of a portion of the at least one listen-before-talk procedure; and
transmitting one or more instances of the sidelink synchronization signal block in accordance with the sidelink synchronization signal block timing configuration and an outcome of the at least one listen-before-talk procedure.

2. The method of claim 1, further comprising:
determining a failure of a first listen-before-talk procedure during a first listen-before-talk occasion of the timing window; and
participating in at least a second listen-before-talk procedure in a second listen-before-talk occasion following the first listen-before-talk occasion of the timing window based at least in part on the duration, wherein the duration of the timing window is sufficient to allow the number of configured repetitions of the sidelink synchronization signal block to be transmitted despite the failure of the first listen-before-talk procedure.

3. The method of claim 1, wherein receiving the message indicating the sidelink synchronization signal block timing configuration further comprises:
identifying that the sidelink synchronization signal block timing configuration includes more sidelink synchronization signal block transmission occasions than the number of configured repetitions of the sidelink synchronization signal block.

4. The method of claim 1, wherein the sidelink synchronization signal block timing configuration further indicates a value for an offset, the method further comprising:
participating in a first listen-before-talk procedure at a first sidelink synchronization signal block occasion of the timing window, wherein the value for the offset indicates a timing for the first sidelink synchronization signal block occasion relative to a beginning of the sidelink synchronization signal block period.

5. The method of claim 1, wherein transmitting the one or more instances of the sidelink synchronization signal block comprises:
transmitting the one or more instances of the sidelink synchronization signal block consecutively in the timing window within the sidelink synchronization signal block period.

6. The method of claim 1, wherein the periodicity of the timing window is equal to a periodicity of the sidelink synchronization signal block period.

7. The method of claim 6, wherein the periodicity of the timing window comprises 160 milliseconds.

8. The method of claim 1, wherein the periodicity of the timing window is equal to a periodicity of the sidelink synchronization signal block period divided by a quantity of bursts of the multiple sidelink synchronization signal block transmission occasions within the sidelink synchronization signal block period.

9. The method of claim 1, wherein the duration is greater than a length of the number of configured repetitions of the sidelink synchronization signal block within the sidelink synchronization signal block period.

10. The method of claim 1, further comprising:
receiving, from the network entity, a radio resource control message that indicates the sidelink synchronization signal block timing configuration.

11. The method of claim 1, wherein the sidelink synchronization signal block timing configuration, the periodicity, the duration of the timing window, or any combination thereof, are preconfigured.

12. The method of claim 1, further comprising:
including, within the one or more instances of the sidelink synchronization signal block, information indicative of a slot index configuration for each of the one or more instances of the sidelink synchronization signal block, wherein the slot index configuration includes a common portion for each of the one or more instances of the sidelink synchronization signal block.

13. The method of claim 12, further comprising:
determining, in accordance with the slot index configuration, a set of slot indices for identifying multiple slot locations corresponding to the one or more instances of the sidelink synchronization signal block, wherein each slot index of the set of slot indices comprise multiple most significant bits, multiple least significant bits, and a toggle bit.

14. The method of claim 13, wherein a value of the multiple least significant bits for a first slot index is equal to a value of the multiple least significant bits at a later slot index, the method further comprising:
identifying a timing difference between the first slot index and the later slot index based at least in part on the toggle bit of the first slot index being different from the toggle bit of the later slot index.

15. The method of claim 13, wherein a value of the multiple least significant bits for a first slot index is equal to a value of the multiple least significant bits at a later slot index, the method further comprising:
identifying a timing difference between the first slot index and the later slot index based at least in part on a single bit of the multiple most significant bits of the first slot index being different from a single bit of the multiple most significant bits of the later slot index.

16. The method of claim 13, wherein a value of the toggle bit is changed at a boundary of a subset of the multiple slot locations corresponding to the one or more instances of the sidelink synchronization signal block, the change in the toggle bit indicating a first repetition of multiple least significant bit values corresponding to slot indices of the subset of the multiple slot locations.

17. The method of claim 13, further comprising:
receiving the multiple most significant bits, the multiple least significant bits, and the toggle bit in a sidelink broadcast channel.

18. The method of claim 13, further comprising:
determining a first set of most significant bits of the multiple most significant bits associated with a first slot index of a first synchronization signal block; and
determining respective sets of most significant bits of the multiple most significant bits associated with slot indices that follow the first slot index, wherein the respective sets of most significant bits have a same value as the first set of most significant bits.

19. The method of claim 12, wherein the slot index configuration further indicates a value for an offset and a repetition index within the sidelink synchronization signal block period, the method further comprising:
transmitting a first set of bits corresponding to the offset and a second set of bits corresponding to the repetition index; and
identifying multiple slot locations corresponding to the one or more instances of the sidelink synchronization signal block based at least in part on the offset and the repetition index.

20. The method of claim 19, wherein the offset comprises a time duration between a beginning of a frame and a first transmitted sidelink synchronization signal block of the one or more instances of the sidelink synchronization signal block.

21. The method of claim 19, wherein the offset is based at least in part on successfully performing the at least one listen-before-talk procedure.

22. The method of claim 19, wherein the repetition index indicates slot indices of the multiple slot locations within the sidelink synchronization signal block period.

23. The method of claim 19, further comprising:
determining the multiple slot locations based at least in part on a direct frame number, a system frame number, the offset, the repetition index, or any combination thereof.

24. A method for wireless communication, comprising:
receiving one or more sidelink synchronization signal blocks within a timing window that includes multiple sidelink synchronization signal block reception occasions and that is within a sidelink synchronization signal block period; and
receiving, within the one or more sidelink synchronization signal blocks, information indicative of a slot index configuration for each of the one or more sidelink synchronization signal blocks, wherein the slot index configuration includes a portion that is common for each of the one or more sidelink synchronization signal blocks.

25. The method of claim 24, wherein a periodicity of the timing window is equal to a periodicity of the sidelink synchronization signal block period or to a periodicity of the sidelink synchronization signal block period divided by a quantity of the multiple sidelink synchronization signal block reception occasions within the sidelink synchronization signal block period.

26. The method of claim 24, further comprising:
determining, in accordance with the slot index configuration, a set of slot indices for identifying multiple slot locations corresponding to the one or more sidelink synchronization signal blocks, wherein each slot index of the set of slot indices comprise multiple most significant bits, multiple least significant bits, and a toggle bit; and
identifying a timing difference between a first slot index and a later slot index based at least in part on the toggle bit of the first slot index being different from the toggle bit of the later slot index.

27. The method of claim 26, wherein a value of the multiple least significant bits for the first slot index is equal to a value of the multiple least significant bits at the later slot index, the method further comprising:
identifying the timing difference between the first slot index and the later slot index based at least in part on a single bit of the multiple most significant bits of the first slot index being different from a single bit of the multiple most significant bits of the later slot index.

28. The method of claim 24, wherein the slot index configuration further indicates a value for an offset and a repetition index within the sidelink synchronization signal block period, the method further comprising:
receiving a first set of bits corresponding to the offset and a second set of bits corresponding to the repetition index; and
identifying multiple slot locations corresponding to the one or more sidelink synchronization signal blocks based at least in part on the offset and the repetition index.

29. An apparatus for wireless communication, comprising:
a processor;
memory coupled with the processor; and
instructions stored in the memory and executable by the processor to cause the apparatus to:
receive, from a network entity, a message indicating a sidelink synchronization signal block timing configuration for a timing window that includes multiple sidelink synchronization signal block transmission occasions and that is within a sidelink synchronization signal block period, the message also indicative of a periodicity and a duration of the timing window within the sidelink synchronization signal block period;
participate in at least one listen-before-talk procedure during the duration of the timing window, the multiple sidelink synchronization signal block transmission occasions provided by the sidelink synchronization signal block timing configuration being more numerous than a number of configured repetitions of a sidelink synchronization signal block within the timing window in order to compensate for failure of a portion of the at least one listen-before-talk procedure; and
transmit one or more instances of the sidelink synchronization signal block in accordance with the sidelink synchronization signal block timing configuration and an outcome of the at least one listen-before-talk procedure.

30. An apparatus for wireless communication, comprising:
a processor;
memory coupled with the processor; and
instructions stored in the memory and executable by the processor to cause the apparatus to:
receive one or more sidelink synchronization signal blocks within a timing window that includes multiple sidelink synchronization signal block reception occasions and that is within a sidelink synchronization signal block period; and
receive, within the one or more sidelink synchronization signal blocks, information indicative of a slot index configuration for each of the one or more sidelink synchronization signal blocks, wherein the slot index configuration includes a portion that is common for each of the one or more sidelink synchronization signal blocks.
